(19) United States
(12) Patent Application Publication
(10) Pub. No.: US 2023/0035310 A1
(43) Pub. Date: Feb. 2, 2023

(54) SYSTEMS THAT DEPLOY AND MANAGE APPLICATIONS WITH HARDWARE DEPENDENCIES IN DISTRIBUTED COMPUTER SYSTEMS AND METHODS INCORPORATED IN THE SYSTEMS

(71) Applicant: VMware, Inc., Palo Alto, CA (US)

(72) Inventors: Frank Denneman, Utrecht (NL); Cormac Hogan, Ballincollig (IE); Duncan Epping, Utrecht (NL)

(73) Assignee: VMware, Inc., Palo Alto, CA (US)

(21) Appl. No.: 17/534,309

(22) Filed: Nov. 23, 2021

Related U.S. Application Data
(60) Provisional application No. 63/226,420, filed on Jul. 28, 2021.

(51) Int. Cl. G06F 9/455; G06F 9/50; G06F 8/60; G06F 9/48; G06N 3/08

(52) U.S. Cl. CPC G06F 9/45558; G06F 9/5077; G06F 8/60; G06F 9/4843; G06N 3/08; G06F 2009/45591

(57) ABSTRACT

The current document is directed to methods and systems that automatically deploy and manage applications that are associated with hardware dependencies. As one example, many machine-learning-based applications use specialized hardware accelerators during training phases since, in many cases, training of machine-learning-based applications and systems would be computationally intractable without the increased computational bandwidth provided by hardware accelerators. However, such hardware dependencies may prevent machine-learning-based applications from being deployed and managed effectively by widely used automated orchestration systems, and manual deployment of applications with hardware dependencies may suffer significant inefficiencies and problems related to maintenance downtime within distributed computer systems. The currently disclosed methods and systems provide centralized maintenance-and-hardware-dependency scheduling information along with an asynchronous protocol for access to the maintenance-and-hardware-dependency scheduling information by automated orchestration systems and managers and administrators of distributed computer systems to facilitate efficient deployment of machine-learning-based applications with hardware dependencies.

### CROSS-REFERENCE TO RELATED APPLICATION

This application claims the benefit of Provisional Application No. 63/226,420, filed Jul. 28, 2021.

### TECHNICAL FIELD

The current document is directed to distributed-computer-systems and, in particular, to systems, and methods incorporated within the systems, that automatically deploy and manage applications that are associated with hardware dependencies.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. The advent of distributed computer systems has provided a computational platform for increasingly complex distributed applications, including service-oriented applications. Distributed applications, including service-oriented applications and microservices-based applications, provide many advantages, including efficient scaling to respond to changes in workload, efficient functionality compartmentalization that, in turn, provides development and management efficiencies, flexible response to system component failures, straightforward incorporation of existing functionalities, and straightforward expansion of functionalities and interfaces with minimal interdependencies between different types of distributed-application instances. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems and applications has, in turn, become increasingly complex, involving greater computational overheads and significant inefficiencies and deficiencies. In fact, many desired management-and-administration functionalities are becoming sufficiently complex to render traditional approaches to the design and implementation of automated management and administration subsystems impractical, from a time and cost standpoint. Therefore, designers and developers of distributed computer systems and applications continue to seek new approaches to implementing automated management-and-administration facilities and functionalities.

### SUMMARY

The current document is directed to methods and systems that automatically deploy and manage applications that are associated with hardware dependencies. As one example, many machine-learning-based applications use specialized hardware accelerators during training phases since, in many cases, training of machine-learning-based applications and systems would be computationally intractable without the increased computational bandwidth provided by hardware accelerators. However, such hardware dependencies may prevent machine-learning-based applications from being deployed and managed effectively by widely used automated orchestration systems, and manual deployment of applications with hardware dependencies may suffer significant inefficiencies and problems related to maintenance downtime within distributed computer systems. The currently disclosed methods and systems provide centralized maintenance-and-hardware-dependency scheduling information along with an asynchronous protocol for access to the maintenance-and-hardware-dependency scheduling information by automated orchestration systems and managers and administrators of distributed computer systems to facilitate efficient deployment of machine-learning-based applications with hardware dependencies.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates fundamental components of a feed-forward neural network.

FIG. 12 illustrates a small, example feed-forward neural network.

FIG. 13 provides a concise pseudocode illustration of the implementation of a simple feed-forward neural network.

FIG. 14 illustrates back propagation of errors through a neural network during training.

FIGS. 15A-B show the details of the weight-adjustment calculations carried out during back propagation.

FIG. 16A-B illustrate neural-network training as an example of machine-learning-based-subsystem training.

FIG. 17 illustrates a fundamental Kubernetes abstraction.

FIG. 18 illustrates a next level of abstraction provided by Kubernetes, referred to as a “Kubernetes cluster.”

FIG. 19 illustrates the logical contents of a pod.

FIG. 20 illustrates the logical contents of a Kubernetes management node and a Kubernetes worker node.

FIGS. 21A-E illustrate operation of a Kubernetes cluster.

FIG. 22 illustrates the Tanzu Kubernetes Grid (“TKG”) containerized-application automated orchestration system.

FIG. 23 illustrates the nature of certain application dependencies.

FIGS. 24A-B illustrate general characteristics of a typical central processing unit (“CPU”).

FIGS. 25A-B illustrate general characteristics of a typical GPU.

FIGS. 26A-B provide an example of the increase in speed of a simple matrix operation obtained by use of a GPU to accelerate component arithmetic operations.

FIGS. 27A-F illustrate a matrix-operation-based method for neural-network training that allows for straightforward GPU acceleration.

FIGS. 28A-F illustrate one problem domain specifically addressed by the currently disclosed methods and systems.

FIGS. 29A-B illustrate two possible approaches to addressing the problem of deploying machine-learning-based application instances on computational nodes of a distributed computer system.

FIG. 30 illustrates two different control planes that provide functionalities used by the currently disclosed methods and systems.

FIGS. 31A-C illustrate a logical, centrally managed maintenance-and-training schedule that provides a basis for the currently disclosed methods and systems.

FIG. 32 illustrates two metrics used in the subsequent discussion of one implementation of the currently disclosed methods and systems.

FIG. 33 illustrates a process by which machine-learning-based workloads requiring hardware acceleration are submitted to, and processed by, an enhanced Kubernetes automated orchestration system.

FIG. 34 illustrates additional details regarding operation of the accelerator-time operator.

FIG. 35 illustrates vCenter-mediated portions of the currently disclosed methods and systems.

FIG. 36 provides a complete view of the steps and components illustrated in FIGS. 33-35.

### DETAILED DESCRIPTION

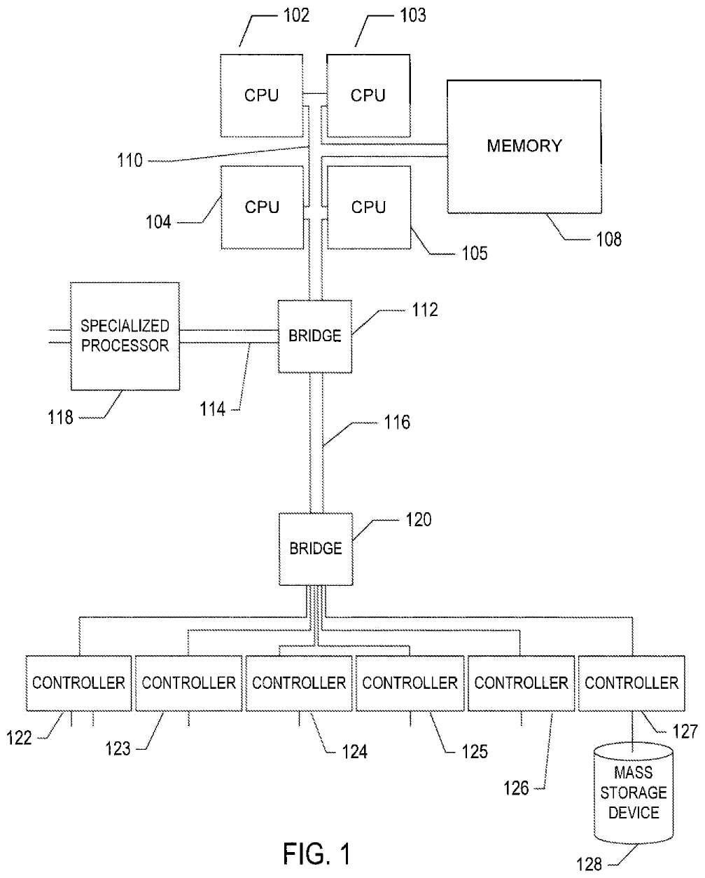

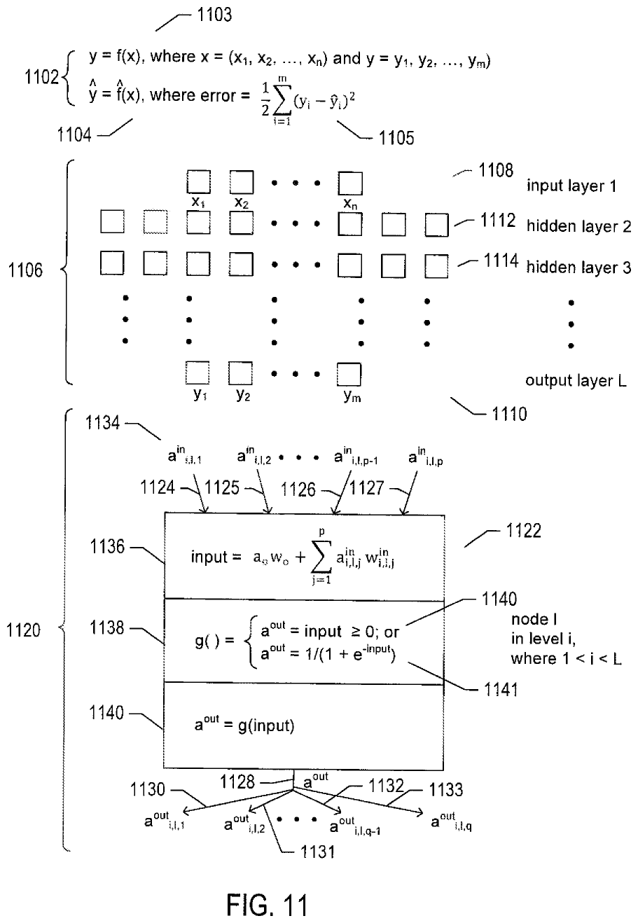

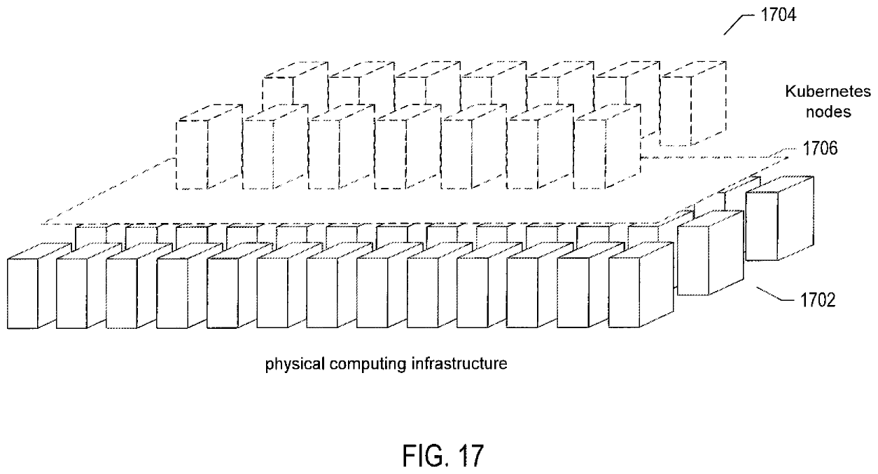

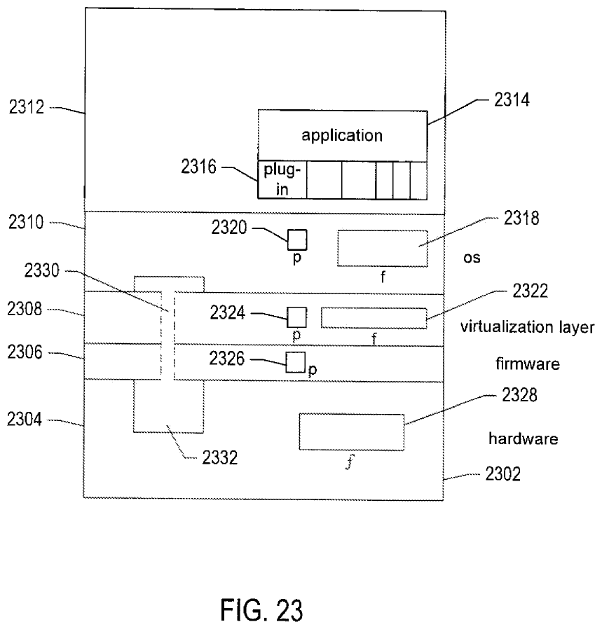

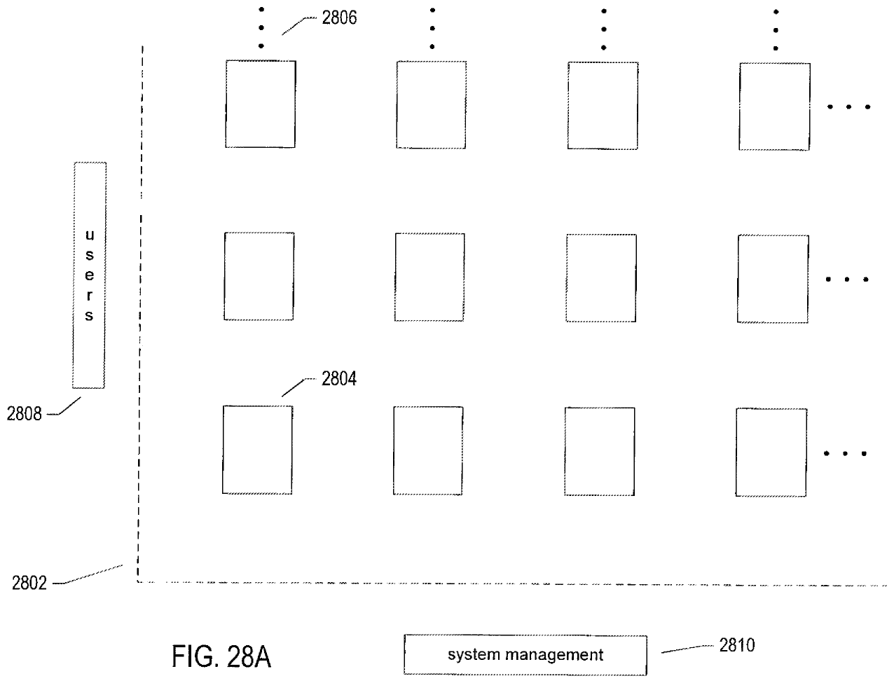

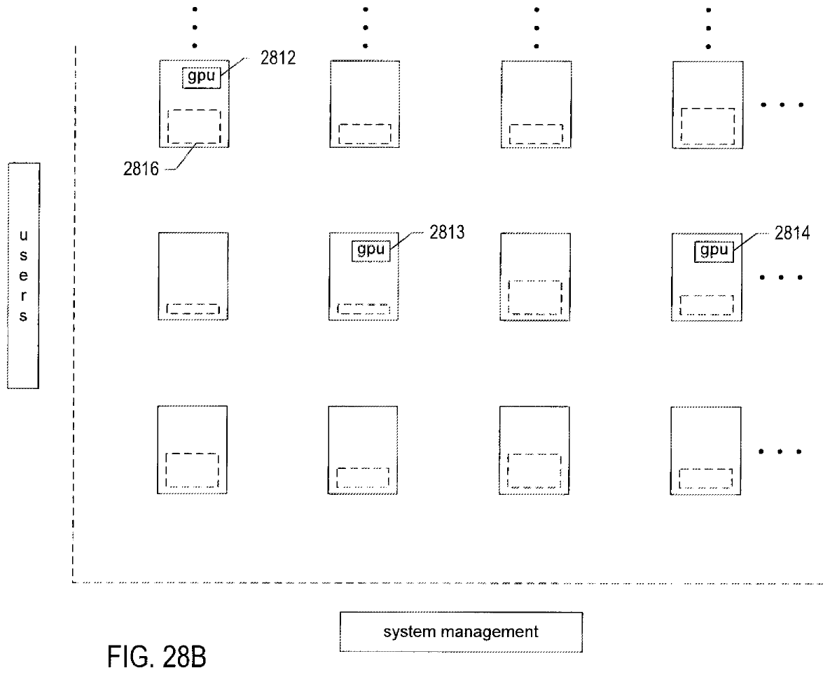

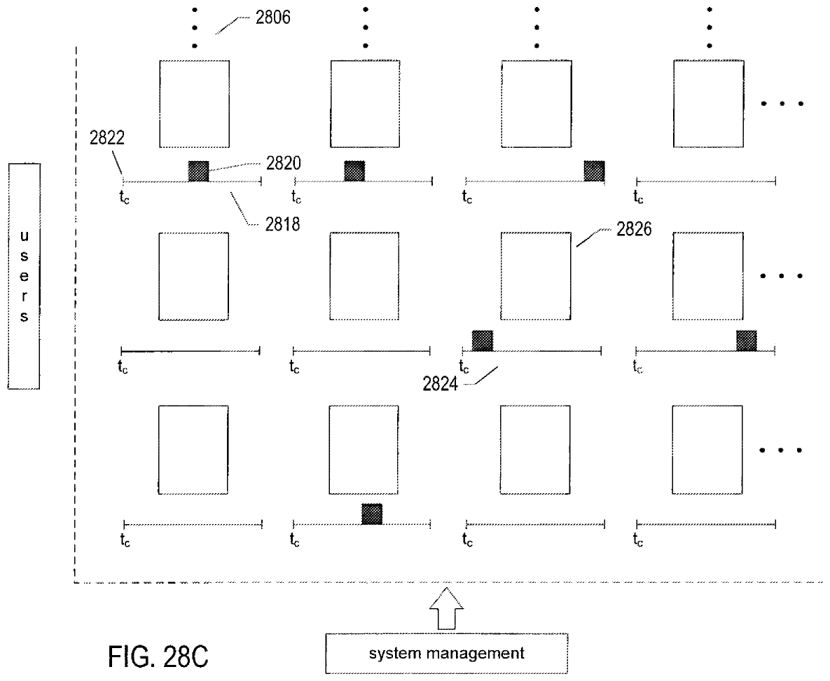

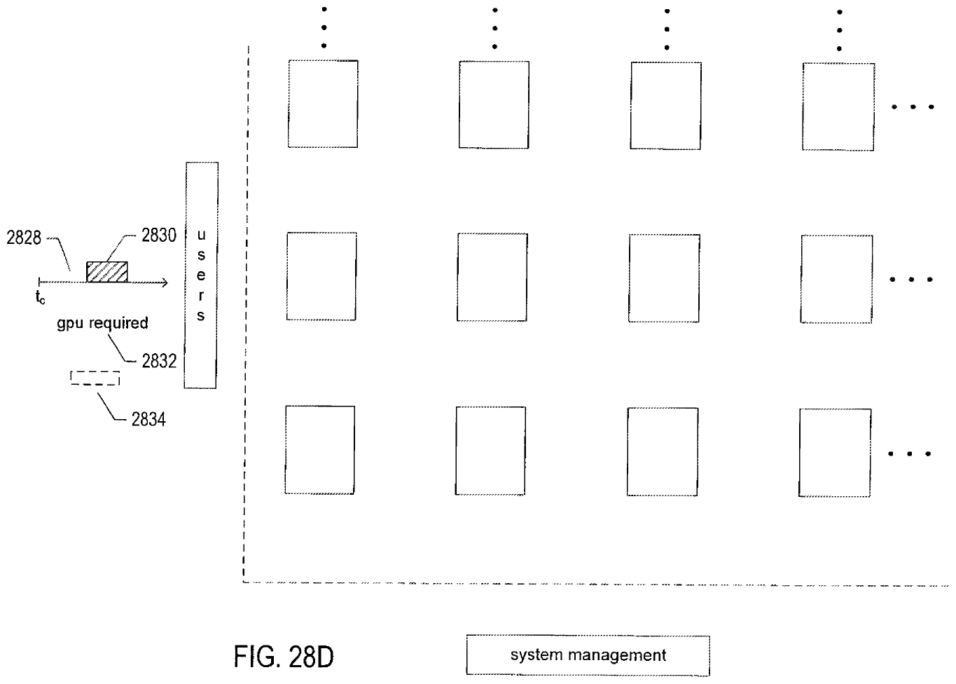

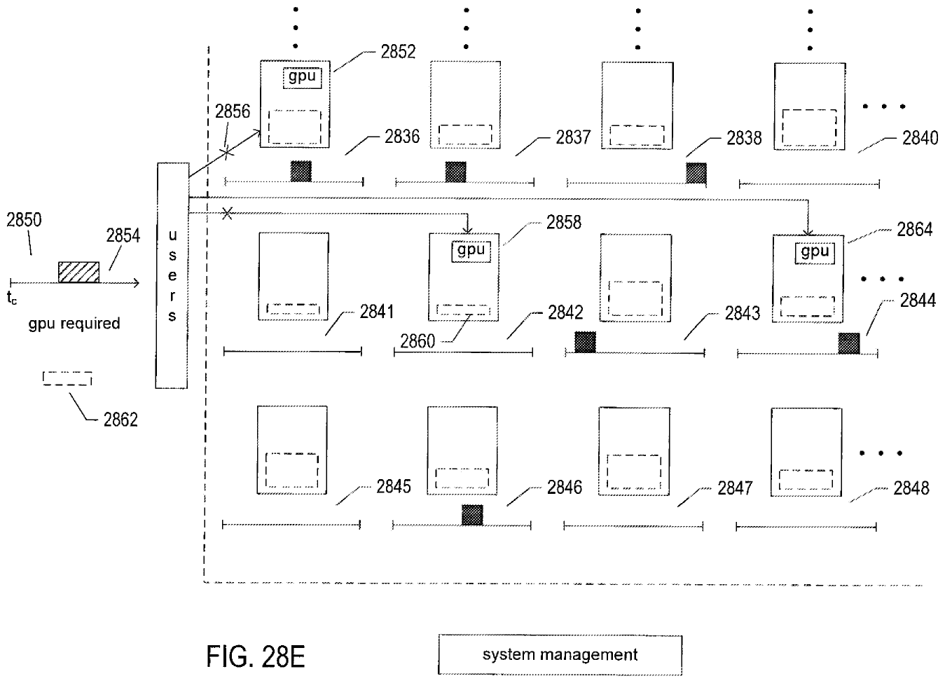

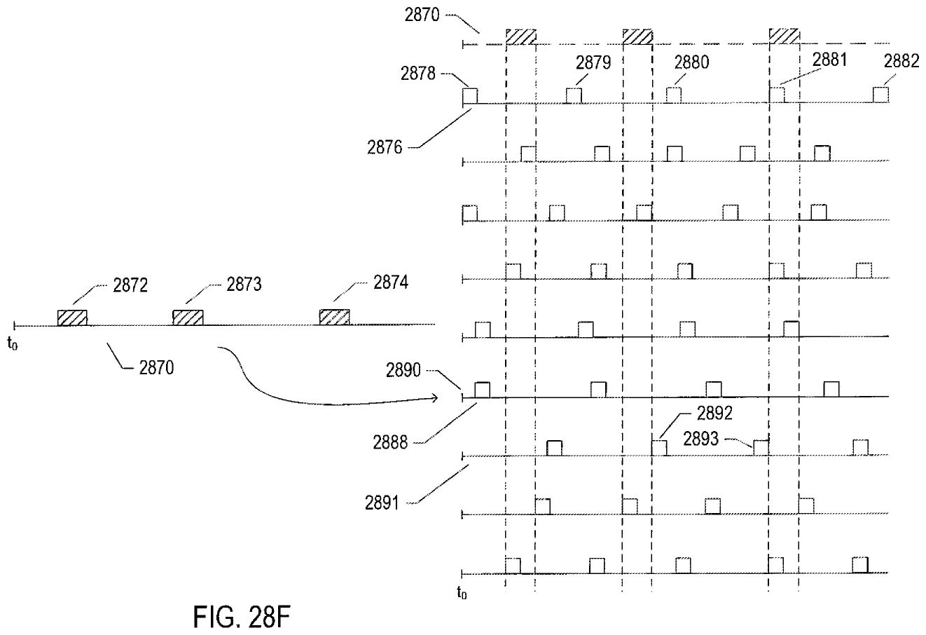

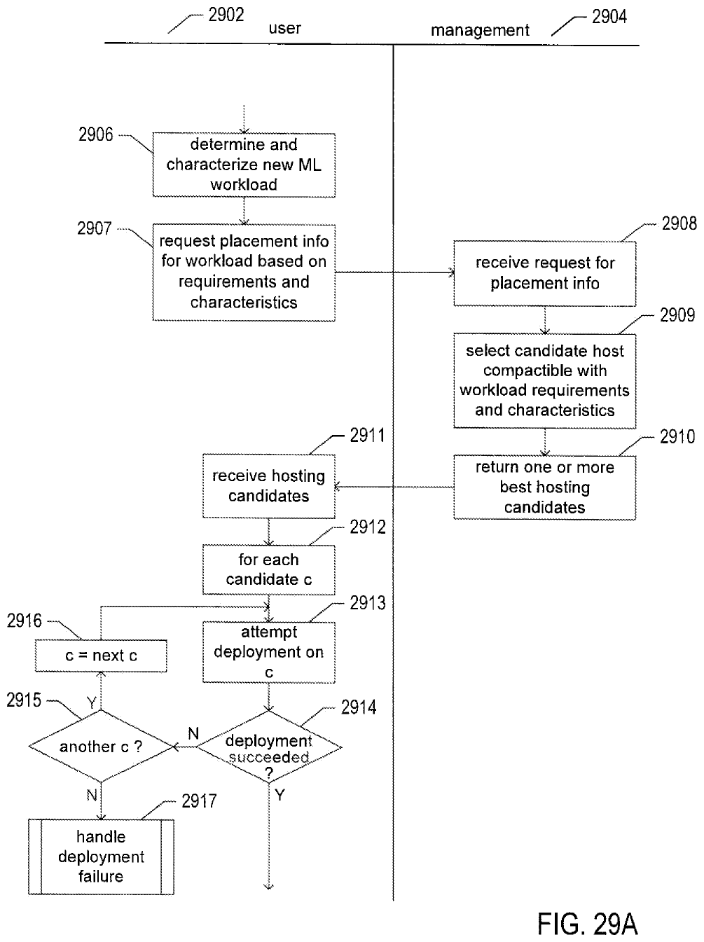

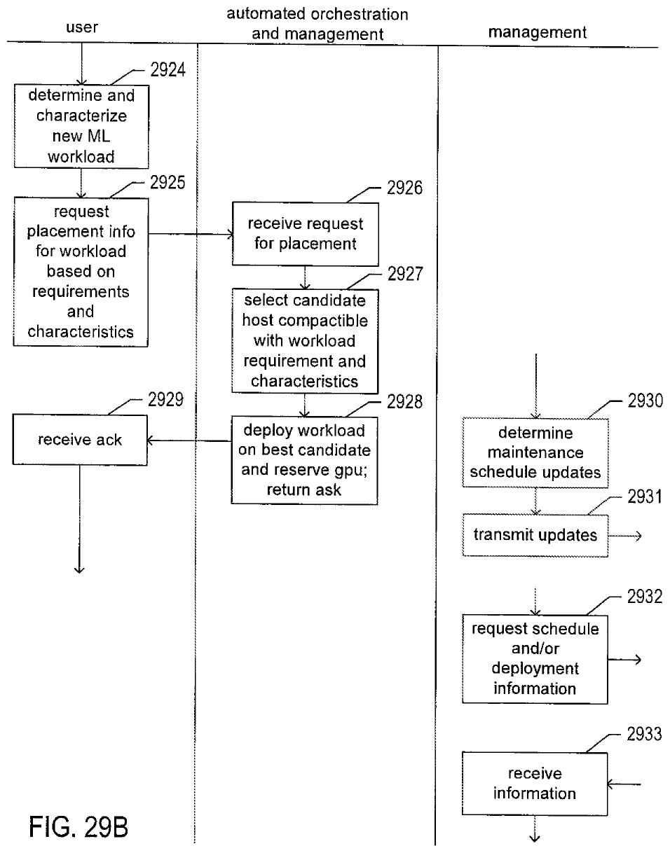

The current document is directed to systems, and methods incorporated within the systems, that automatically deploy and manage applications that are associated with hardware dependencies. In a first subsection, below, a detailed description of computer hardware, complex computational systems, and virtualization is provided with reference to FIGS. 1-10. In a second subsection, neural networks are discussed with reference to FIGS. 11-16B. In a third subsection, a widely used automated orchestration system is discussed with reference to FIGS. 17-22. In a fourth subsection, hardware accelerators for machine-learning applications are discussed, with reference to FIGS. 23-27F. In a fifth subsection, problems with deployment and management of applications with hardware dependencies are discussed with reference to FIGS. 28A-F. Finally, in a sixth subsection, the currently disclosed methods and systems are discussed with reference to FIGS. 29A-36.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

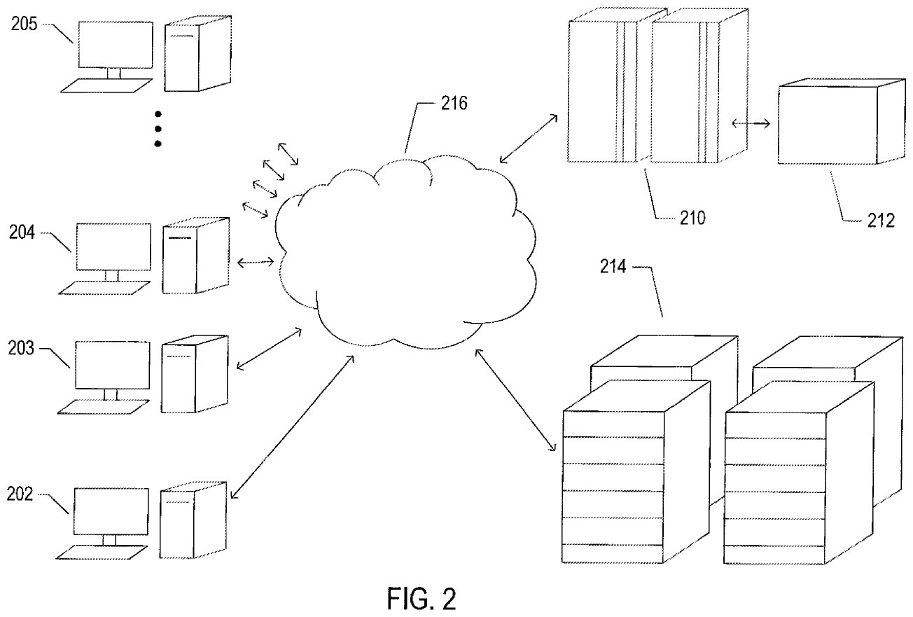

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and ma access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

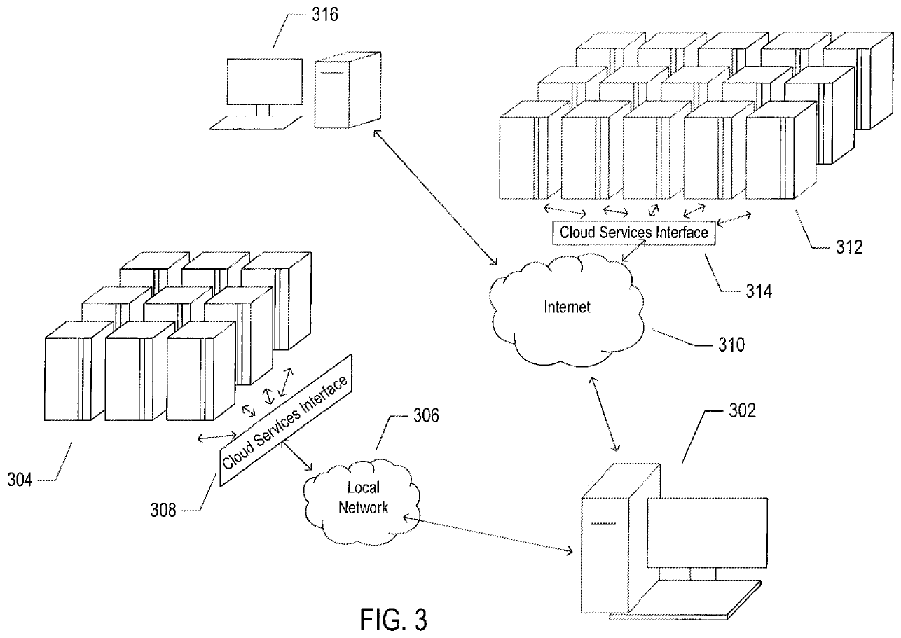

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

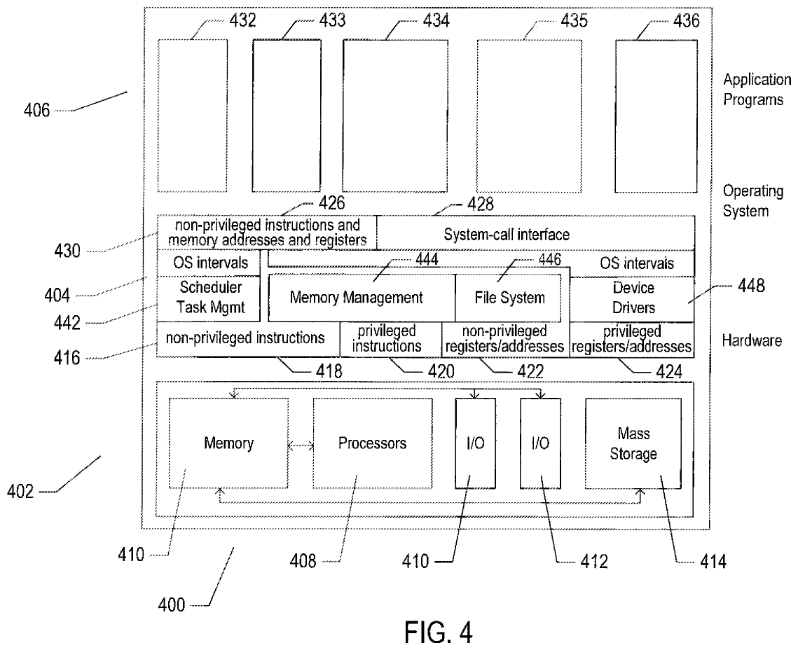

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

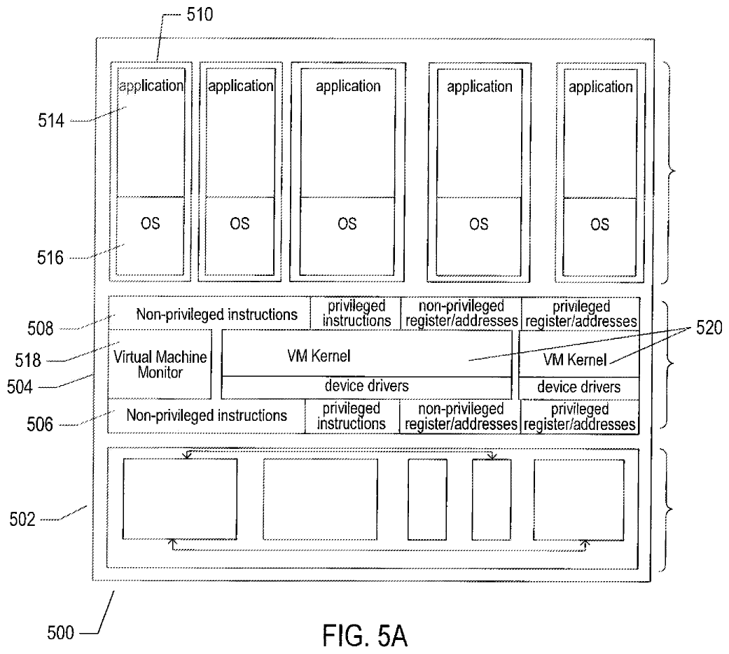

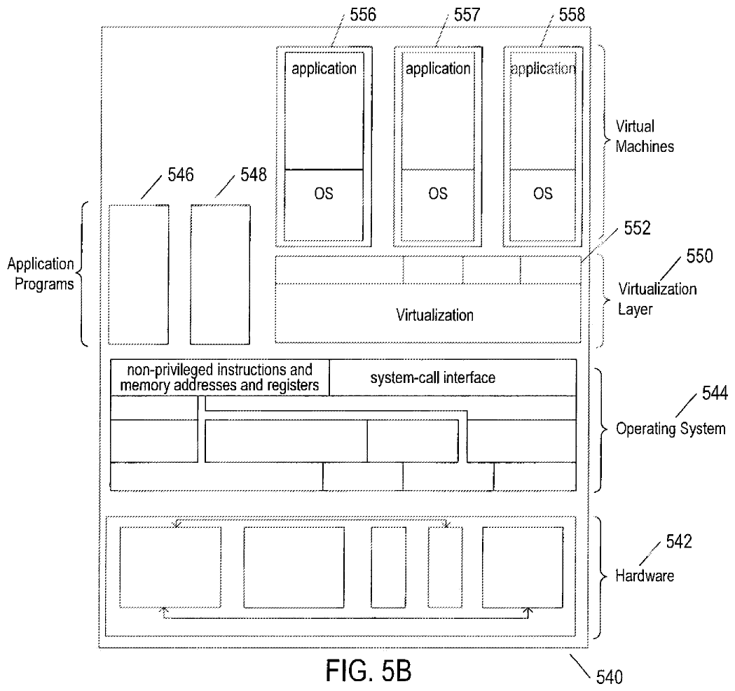

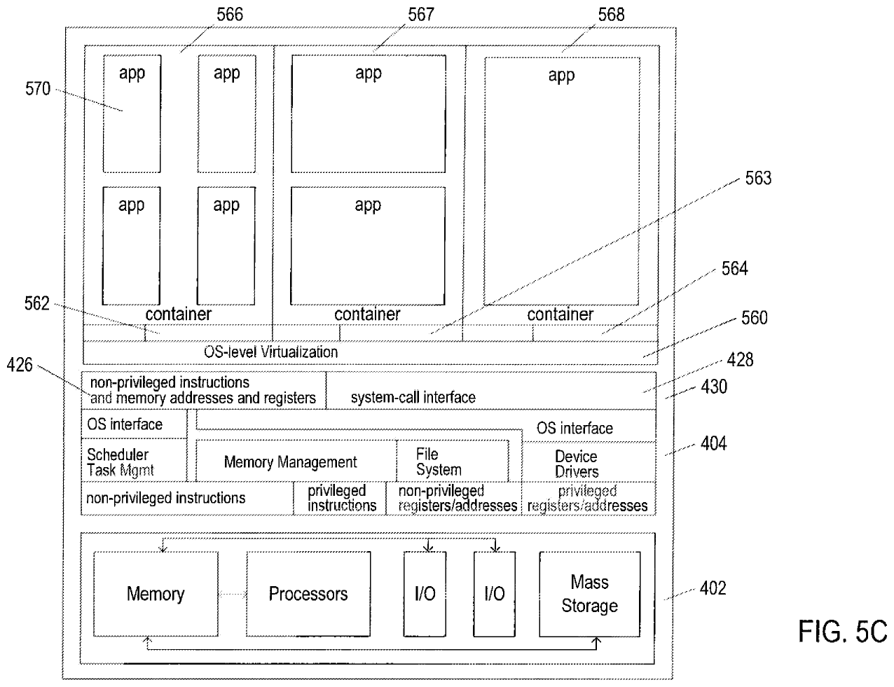

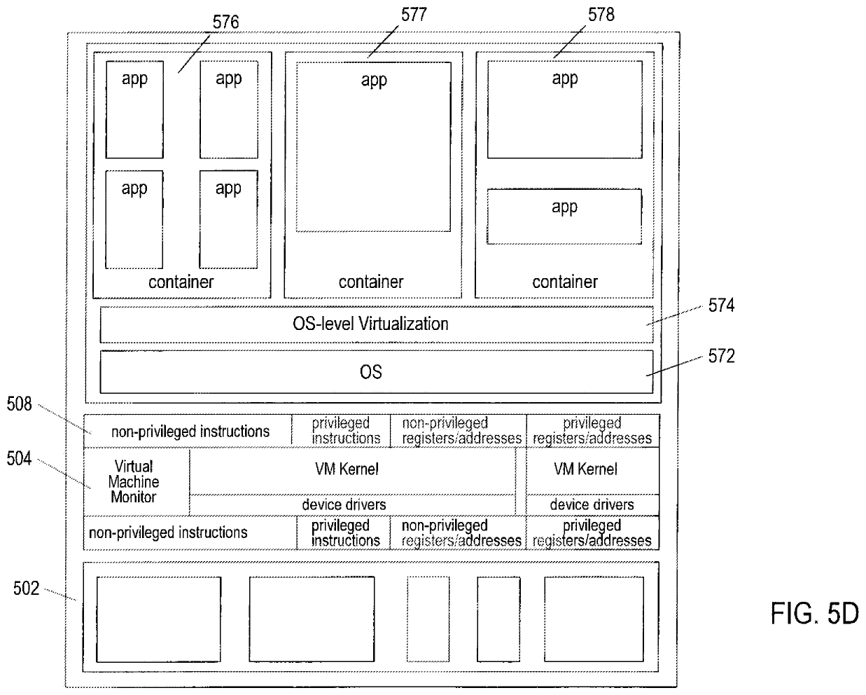

For all of these reasons, a higher level of abstraction, referred to as the “virtual machine.” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

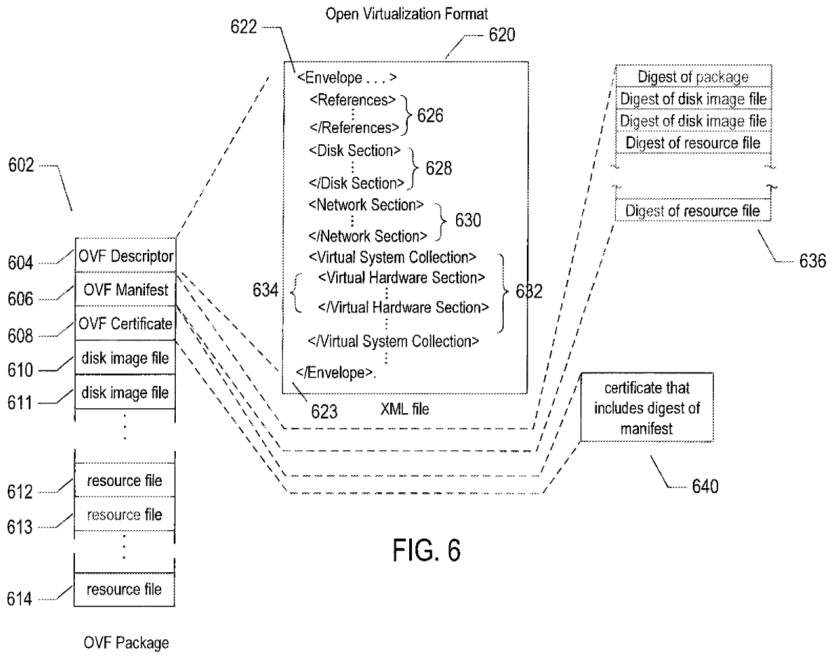

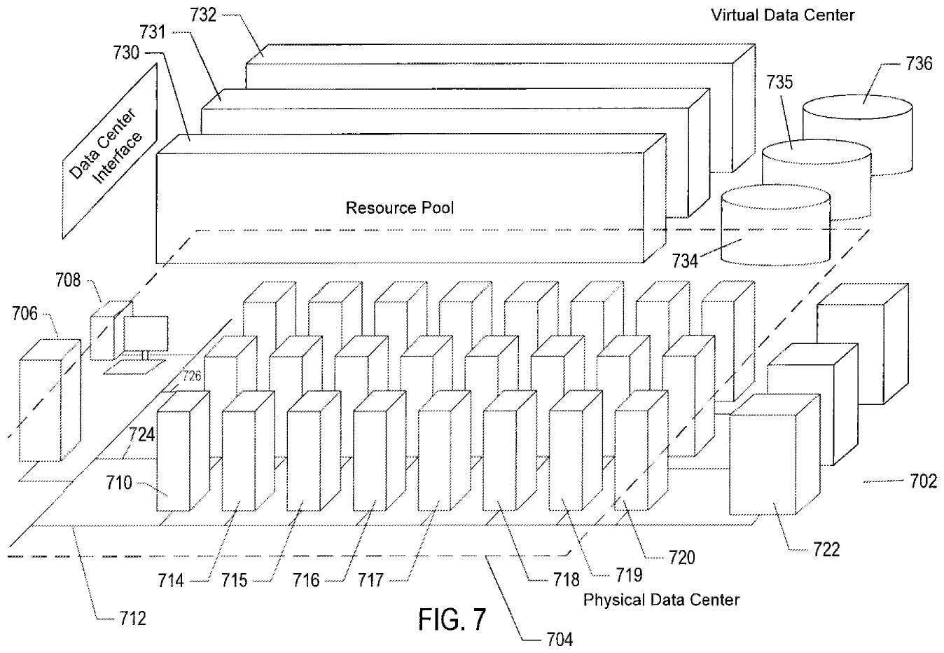

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

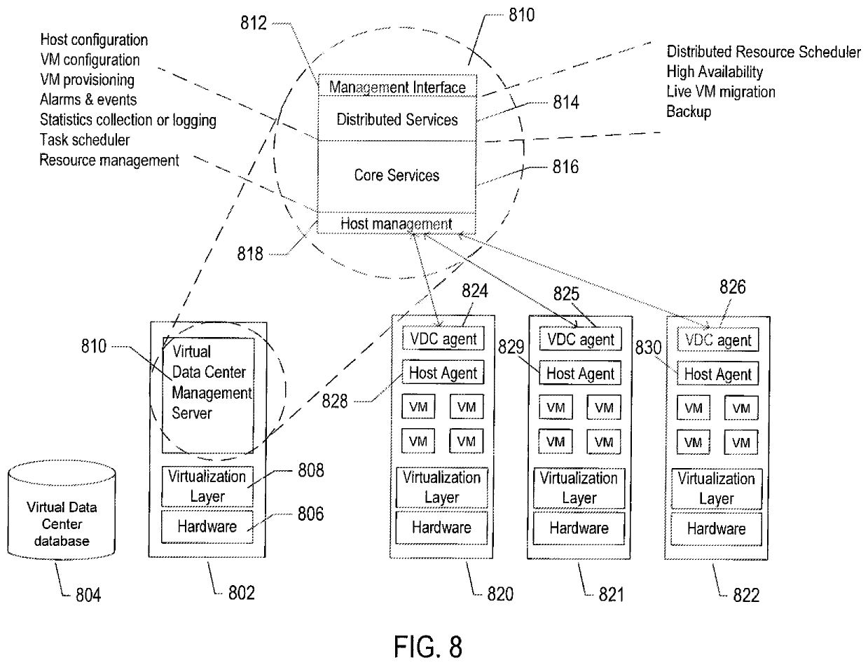

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

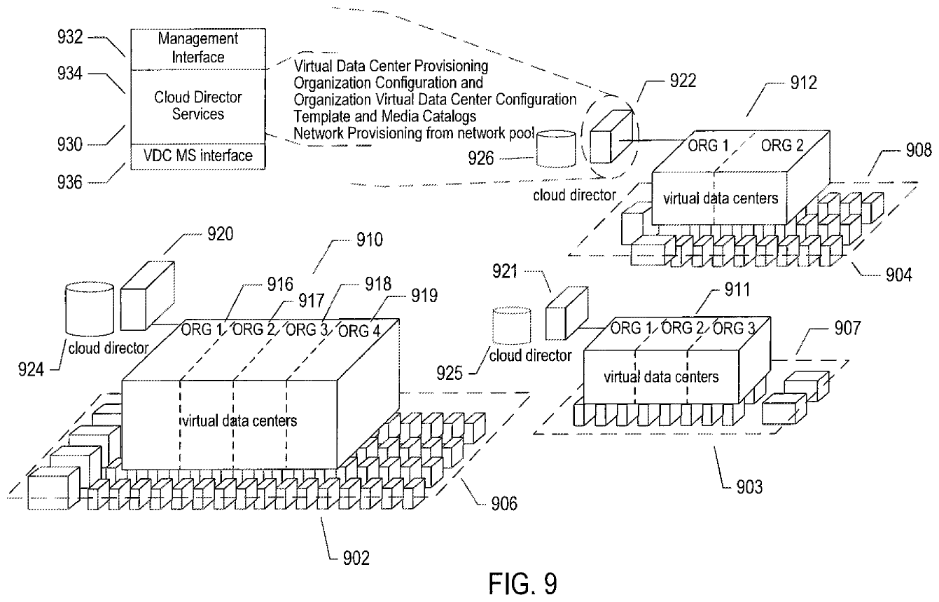

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

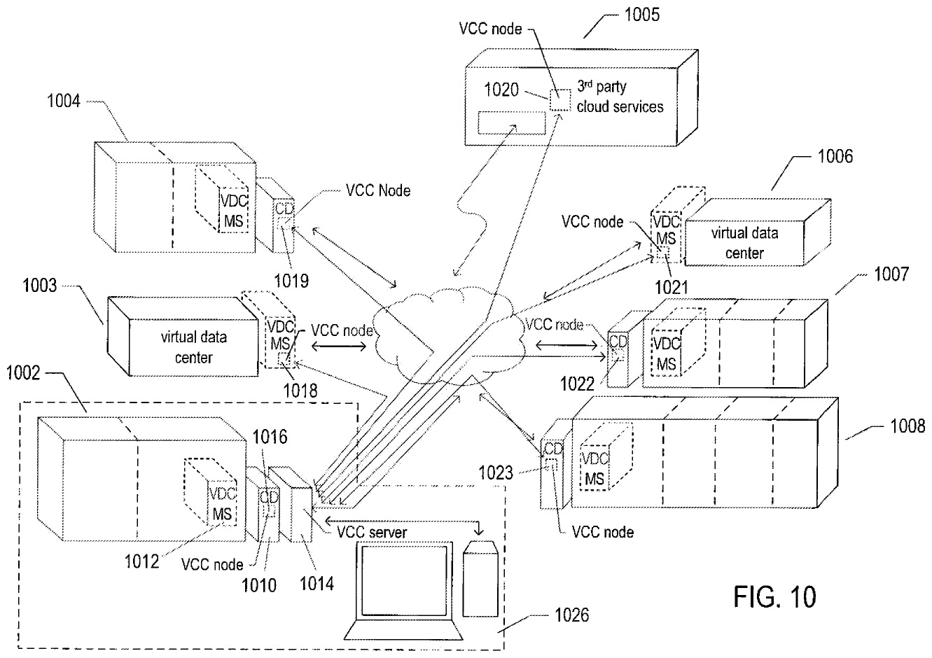

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC servers and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Neural Networks

FIG. 11 illustrates fundamental components of a feed-forward neural network. Equations 1102 mathematically represents ideal operation of a neural network as a function ƒ(x). The function receives an input vector x and outputs a corresponding output vector y 1103. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression 1103 represents the ideal operation of the neural network. In other words, the output vectors y represent the ideal, or desired, output for corresponding input vector x. However, in actual operation, a physically implemented neural network \hat{ƒ}(x), as represented by expressions 1104, returns a physically generated output vector y̅ that may differ from the ideal or desired output vector y. As shown in the second expression 1105 within expressions 1104, an output vector produced by the physically implemented neural network is associated with an error or loss value. A common error or loss value is the square of the distance between the two points represented by the ideal output vector and the output vector produced by the neural network. To simplify back-propagation computations, discussed below, the square of the distance is often divided by 2. As further discussed below, the distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 1106 of FIG. 11, a feed-forward neural network generally consists of layers of nodes, including an input layer 1108, an output layer 1110, and one or more hidden layers 1112 and 1114. These layers can be numerically labeled 1, 2, 3, . . . , L, as shown in FIG. 11. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 11 (1120 in FIG. 11) illustrates a feed-forward neural-network node. The neural-network node 1122 receives inputs 1124-1127 from one or more next-higher-level nodes and generates an output 1128 that is distributed to one or more next-lower-level nodes 1130-1133. The inputs and outputs are referred to as “activations,” represented by superscripted-and-subscripted symbols “a” in FIG. 11, such as the activation symbol 1134. An input component 1136 within a node collects the input activations and generates a weighted sum of these input activations to which a weighted internal activation a₀ is added. An activation component 1138 within the node is represented by a function g( ), referred to as an “activation function.” that is used in an output component 1140 of the node to generate the output activation of the node based on the input collected by the input component 1136. The neural-network node 1122 represents a generic hidden-layer node. Input-layer nodes lack the input component 1136 and each receive a single input value representing an element of an input vector. Output-component nodes output a single value representing an element of the output vector. The values of the weights used to generate the cumulative input by the input component 1136 are determined by training, as previously mentioned. In general, the input, outputs, and activation function are predetermined and constant, although, in certain types of neural networks, these may also be at least partly adjustable parameters. In FIG. 11, two different possible activation functions are indicated by expressions 1140 and 1141. The latter expression represents a sigmoidal relationship between input and output that is commonly used in neural networks and other types of machine-learning systems.

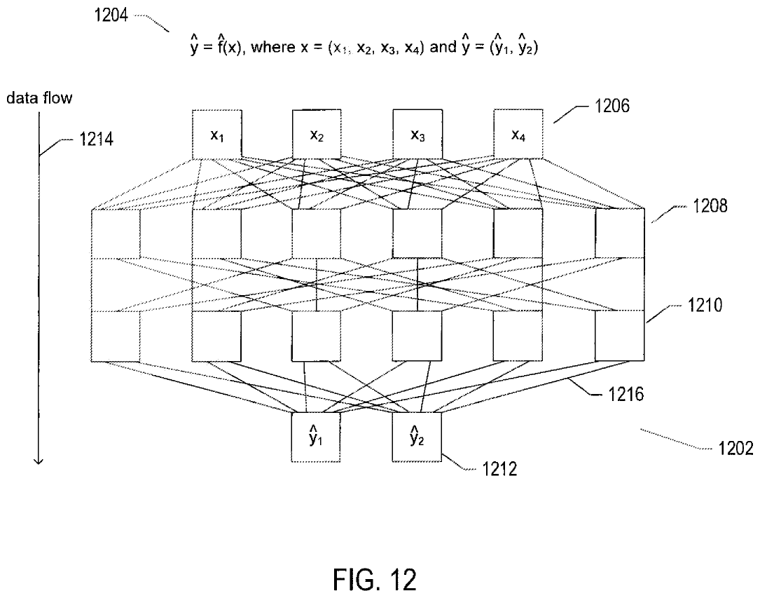

FIG. 12 illustrates a small, example feed-forward neural network, illustrates a small, example feed-forward neural network. The example neural network 1202 is mathematically represented by expression 1204. It includes an input layer of four nodes 1206, a first hidden layer 1208 of six nodes, a second hidden layer 1210 of six nodes, and an output layer 1212 of two nodes. As indicated by directed arrow 1214, data input to the input-layer nodes 1206 flows downward through the neural network to produce the final values output by the output nodes in the output layer 1212. The line segments, such as line segment 1216, interconnecting the nodes in the neural network 1202 indicate communications paths along which activations are transmitted from higher-level nodes to lower-level nodes. In the example feed-forward neural network, the nodes of the input layer 1206 are fully connected to the nodes of the first hidden layer 1208, but the nodes of the first hidden layer 1208 are only sparsely connected with the nodes of the second hidden layer 1210. Various different types of neural networks may use different numbers of layers, different numbers of nodes in each of the layers, and different patterns of connections between the nodes of each layer to the nodes in preceding and succeeding layers.

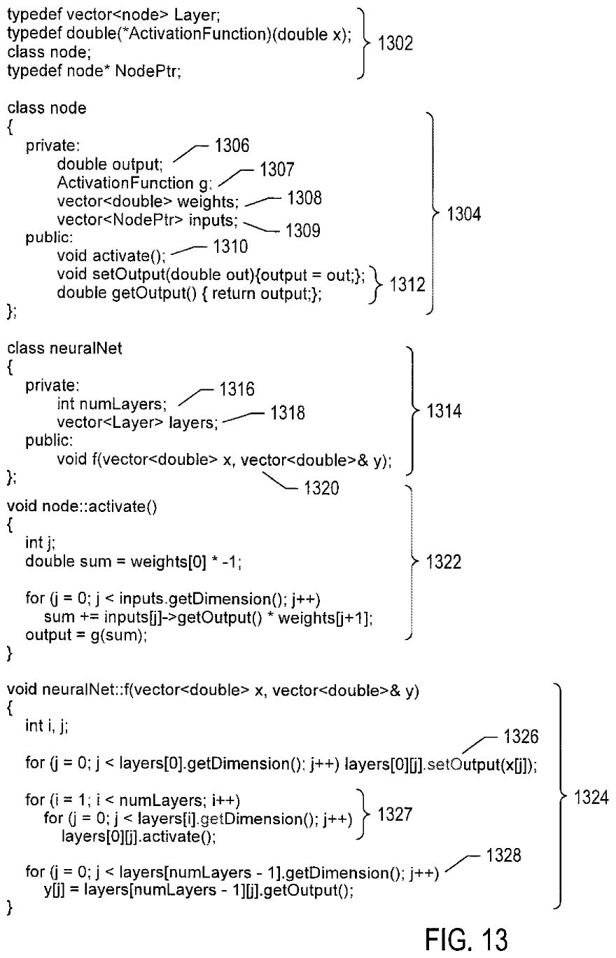

FIG. 13 provides a concise pseudocode illustration of the implementation of a simple feed-forward neural network. Three initial type definitions 1302 provide types for layers of nodes, pointers to activation functions, and pointers to nodes. The class node 1304 represents a neural-network node. Each node includes the following data members: (1) output 1306, the output activation value for the node; (2) g 1307, a pointer to the activation function for the node; (3) weights 1308, the weights associated with the inputs: and (4) inputs 1309, pointers to the higher-level nodes from which the node receives activations. Each node provides an activate member function 1310 that generates the activation for the node, which is stored in the data member output, and a pair of member functions 1312 for setting and getting the value stored in the data member output. The class neuralNet 1314 represents an entire neural network. The neural network includes data members that store the number of layers 1316 and a vector of node-vector layers 1318, each node-vector layer representing a layer of nodes within the neural network. The single member function ƒ 1320 of the class neuralNet generates an output vector y for an input vector x. An implementation of the member function activate for the node class is next provided 1322. This corresponds to the expression shown for the input component 1136 in FIG. 11. Finally, an implementation for the member function ƒ 1324 of the neuralNet class is provided. In a first for-loop 1326, an element of the input vector is input to each of the input-layer nodes. In a pair of nested for-loops 1327, the activate function for each hidden-layer and output-layer node in the neural network is called, starting from the highest hidden layer and proceeding layer-by-layer to the output layer. In a final for-loop 1328, the activation values of the output-layer nodes are collected into the output vector v.

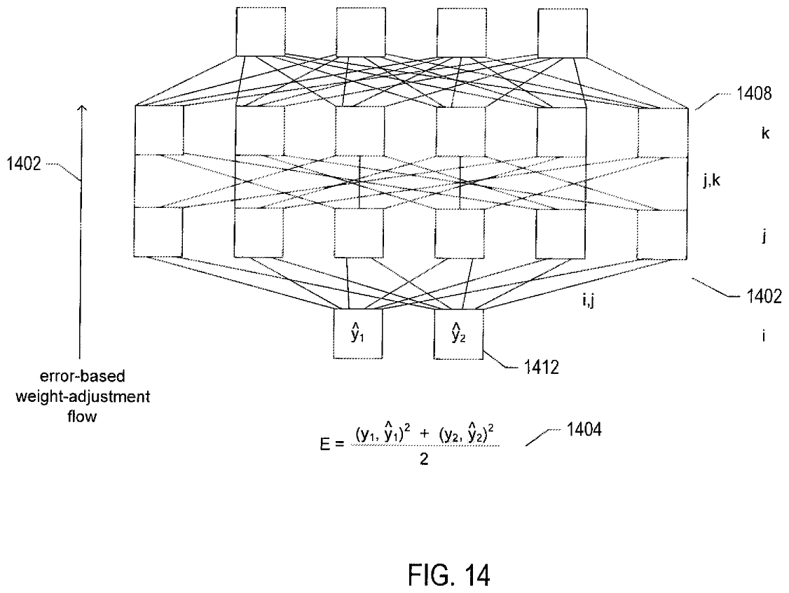

FIG. 14 illustrates back propagation of errors through a neural network during training. As indicated by directed arrow 1402, the error-based weight adjustment flows upward from the output-layer nodes 1212 to the highest-level hidden-layer nodes 1208. For the example neural network 1202, the error, or loss, is computed according to expression 1404. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

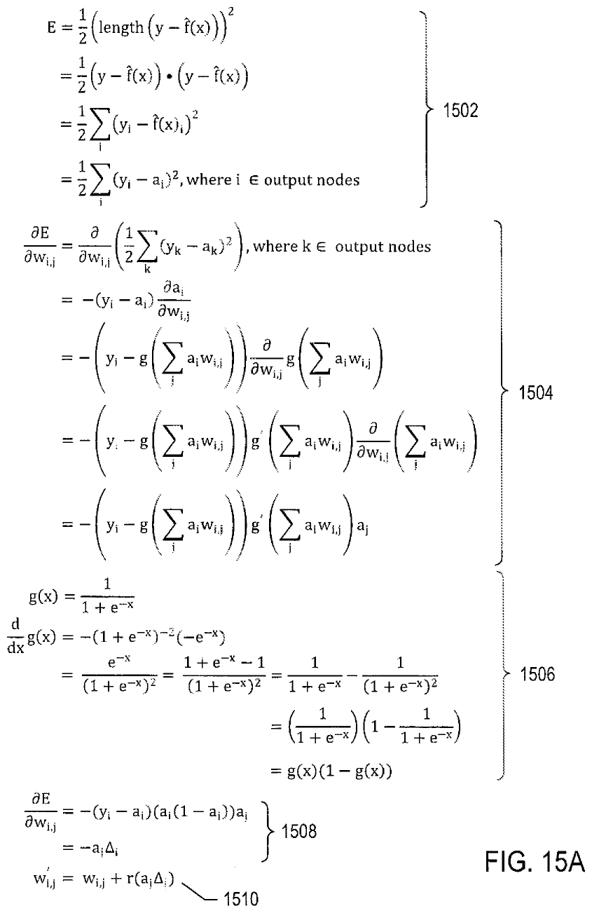

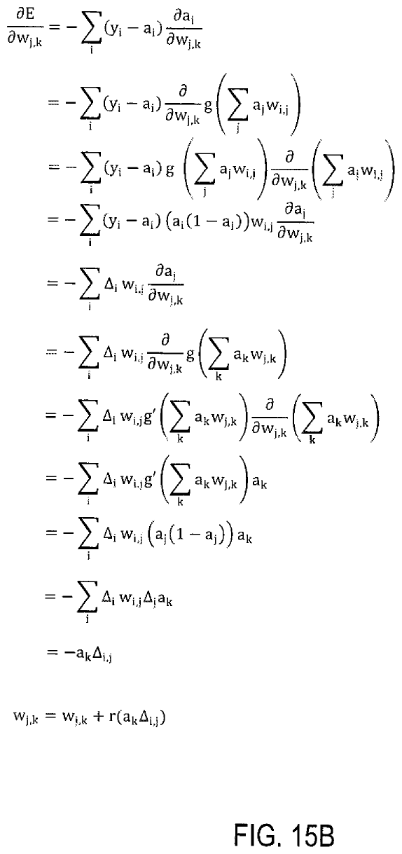

FIGS. 15A-B show the details of the weight-adjustment calculations carried out during back propagation. FIGS. 15A-B show the details of the weight-adjustment calculations carried out during back propagation. An expression for the total error, or loss. E with respect to an input-vector/label pair within a training dataset is obtained in a first set of expressions 1502, which is one half the squared distance between the points in a multidimensional space represented by the ideal output and the output vector generated by the neural network. The partial differential of the total error E with respect to a particular weight w_{i,j} for the j^{th} input of an output node i is obtained by the set of expressions 1504. In these expressions, the partial differential operator is propagated rightward through the expression for the total error E. An expression for the derivative of the activation function with respect to the input x produced by the input component of a node is obtained by the set of expressions 1506. This allows for generation of a simplified expression for the partial derivative of the total energy E with respect to the weight associated with the j^{th} input of the i^{th} output node 1508. The weight adjustment based on the total error E is provided by expression 1510, in which r has a real value in the range [0−1] that represents a learning rate, aⱼ is the activation received through input j by node i, and Δᵢ is the product of parenthesized terms, which include aᵢ and yᵢ, in the first expression in expressions 1508 that multiplies aⱼ FIG. 15B provides a derivation of the weight adjustment for the hidden-layer nodes above the output layer. It should be noted that the computational overhead for calculating the weights for each next highest layer of nodes increases geometrically, as indicated by the increasing number of subscripts for the Δ multipliers in the weight-adjustment expressions.

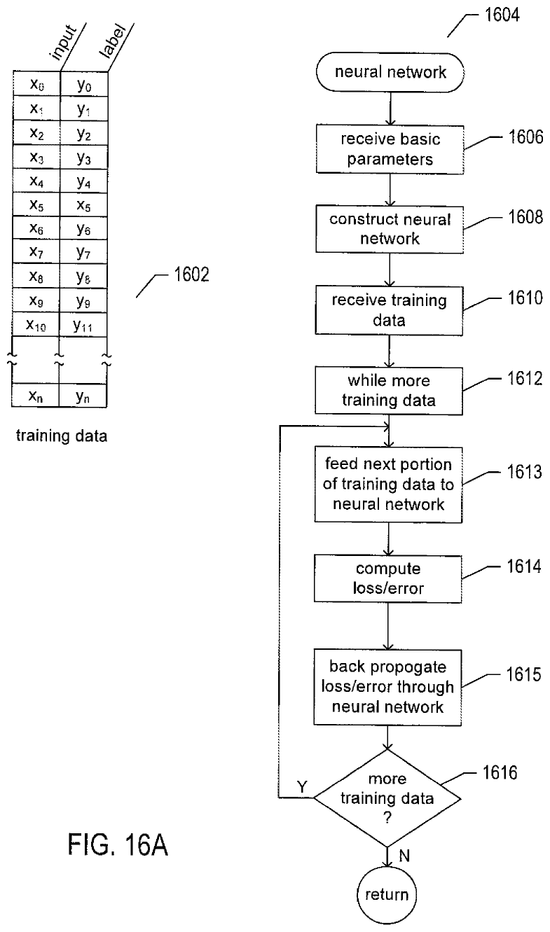

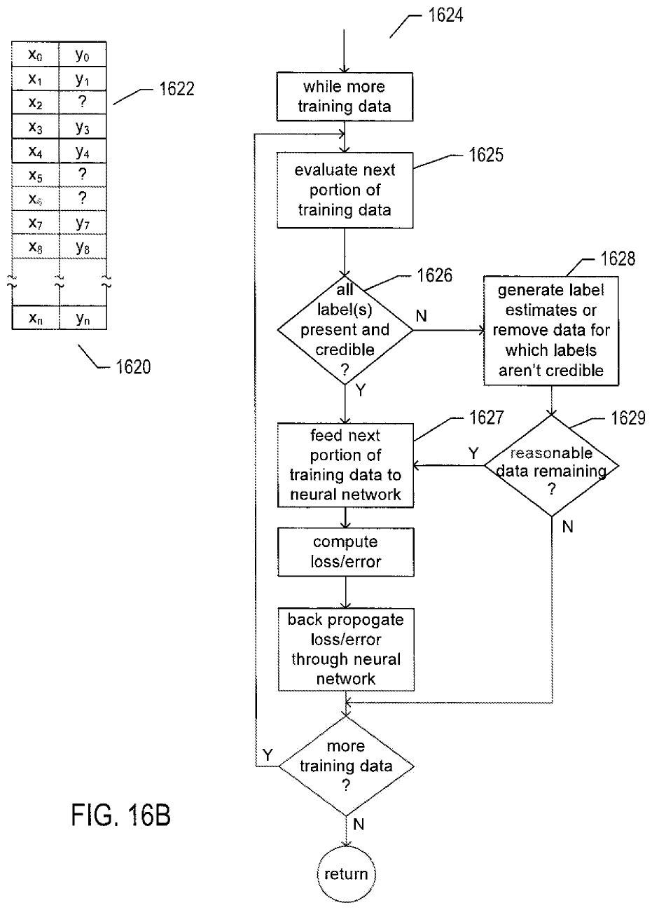

FIG. 16A-B illustrate neural-network training as an example of machine-learning-based-subsystem training. FIG. 16A illustrates the construction and training of a neural network using a complete and accurate training dataset. The training dataset is shown as a table of input-vector/label pairs 1602, in which each row represents an input-vector/label pair. The control-flow diagram 1604 illustrates construction and training of a neural network using the training dataset. In step 1606, basic parameters for the neural network are received, such as the number of layers, number of nodes in each layer, node interconnections, and activation functions. In step 1608, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 1610, training data represented by table 1602 is received. Then, in the while-loop of steps 1612-1616, portions of the training data are iteratively input to the neural network, in step 1613, the loss or error is computed, in step 1614, and the computed loss or error is back-propagated through the neural network step 1615 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 16B illustrates one method of training a neural network using an incomplete training dataset. Table 1620 represents the incomplete training dataset. For certain of the input-vector/label pairs, the label is represented by a “?” symbol, such as in the input-vector/label pair 1622. The “?” symbol indicates that the correct value for the label is unavailable. This type of incomplete data set may arise from a variety of different factors, including inaccurate labeling human annotators, various types of data loss incurred during collection, storage, and processing of training datasets, and other such factors. The control-flow diagram 1624 illustrates alterations in the while-loop of steps 1612-1616 in FIG. 16A that might be employed to train the neural network using the incomplete training dataset. In step 1625, a next portion of the training dataset is evaluated to determine the status of the labels in the next portion of the training data. When all of the labels are present and credible, as determined in step 1626, the next portion of the training dataset is input to the neural network, in step 1627, as in FIG. 16A. However, when certain labels are missing or lack credibility, as determined in step 1626, the input-vector/label pairs that include those labels are removed or altered to include better estimates of the label values, in step 1628. When there is reasonable training data remaining in the training-data portion following step 1628, as determined in step 1629, the remaining reasonable data is input to the neural network in step 1627. The remaining steps in the while-loop are equivalent to those in the control-flow diagram shown in FIG. 16A. Thus, in this approach, either suspect data is removed, or better labels are estimated, based on various criteria, for substitution for the suspect labels.

### Kubernetes

Kubernetes is an automated, open-source containerized-application orchestration system that provides an abstraction layer above virtual and physical computational resources within a data center or cloud-computing facility. Containers are a type of virtualized application-execution environment discussed above with reference to FIGS. 5C-D. Containerized applications are applications that packaged for execution within containers. Kubernetes automatically distributes and schedules containerized applications across physical and virtual computational resources of a data center or cloud-computing facility. As one example, modern service-oriented applications are generally implemented by distributed applications running on the multiple virtual machines or containers within multiple physical servers of a data center or cloud-computing facility. Rather than manually installing and managing all of these different virtual machines and/or containers, a user can develop Kubernetes workload-resource specifications and supply the workload-resource specifications along with references to containerized applications to a Kubernetes automated orchestration system, which instantiates and manages operation of the service-oriented application.

FIG. 17 illustrates a fundamental Kubernetes abstraction. A data center, cloud-computing facility, or other distributed computer system is represented, in FIG. 17, as a large number of physical computational resources, such as servers 1702. Kubernetes abstracts a portion of the physical and virtual computational resources provided by the underlying data center, cloud-computing facility, or other distributed computer system as a set of Kubernetes nodes 1704, where horizontal plane 1706 represents the fundamental Kubernetes abstraction of the underlying physical and virtual computational resources of the data center or cloud-computing facility. Kubernetes nodes may be virtual machines, physical computers, or other such computational entities that provide execution environments for containerized applications. The Kubernetes automated orchestration system is responsible for mapping Kubernetes nodes to the physical and virtual computational resources, including physical and virtual data-storage facilities and communications networks in addition to containerized-application execution environments.

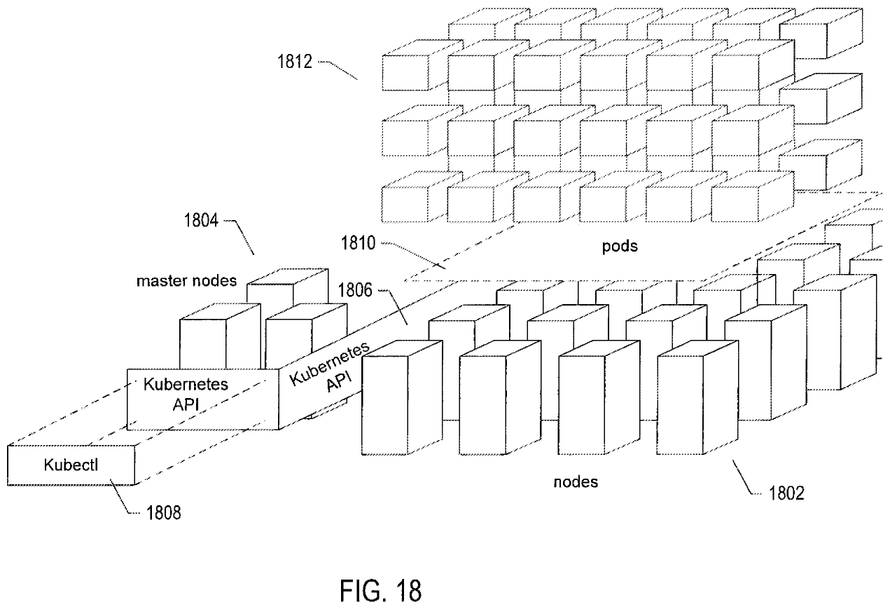

FIG. 18 illustrates a next level of abstraction provided by Kubernetes, referred to as a “Kubernetes cluster.” A Kubernetes cluster comprises a set of highly available, interconnected Kubernetes nodes that are managed by Kubernetes as a computational entity. The nodes in a cluster are partitioned into worker nodes 1802, often simply referred to as “nodes.” and master nodes 1804 that together implement a Kubernetes-cluster control plane. In general, only one of the masters nodes is active at any given time, with the inactive master nodes providing for immediate failover in the case that the active master node fails. The control plane is responsible for distributing containerized applications among the worker nodes and scheduling execution of the containerized applications. In addition, the control plane manages operation of the nodes and containerized applications executing within the nodes. The control plane provides a Kubernetes application programming interface (“API”) 1806 through which the control plane communicates with the nodes and through which Kubernetes services and facilities are accessed by users, often via the Kubectl command line interface 1808. An additional Kubernetes layer of abstraction 1810 provides a set of pods 1812 that are deployed to, and that provide execution environments within, the nodes 1802. A pod is the smallest computational unit in Kubernetes. A pod supports execution of a single container or two or more tightly coupled containers, including shared data-storage and networking resources, that are scheduled and deployed together by the cluster control plane. In many cases, a pod includes only a single container that provides an execution environment for a single instance of a containerized application. Pods are created and managed by controllers for workload resources, discussed below, and are each associated with a pod template, or pod specification.

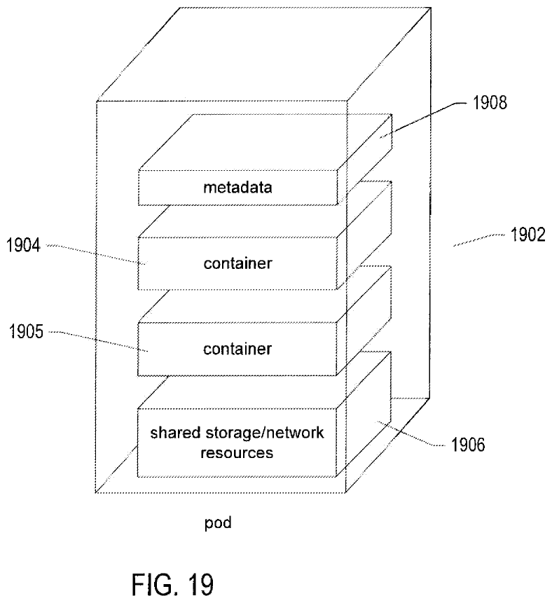

FIG. 19 illustrates the logical contents of a pod. The pod 1902 includes one or more containers 1904-1905, shared storage and networking resources 1906, and various types of metadata 1908, including operational parameters and resource requirements. A pod is assigned a set of unique network addresses that is shared, along with a set of ports, by all of the containers in the pod. Containers within a pod can communicate with one another via shared memory, semaphores, and localhost.

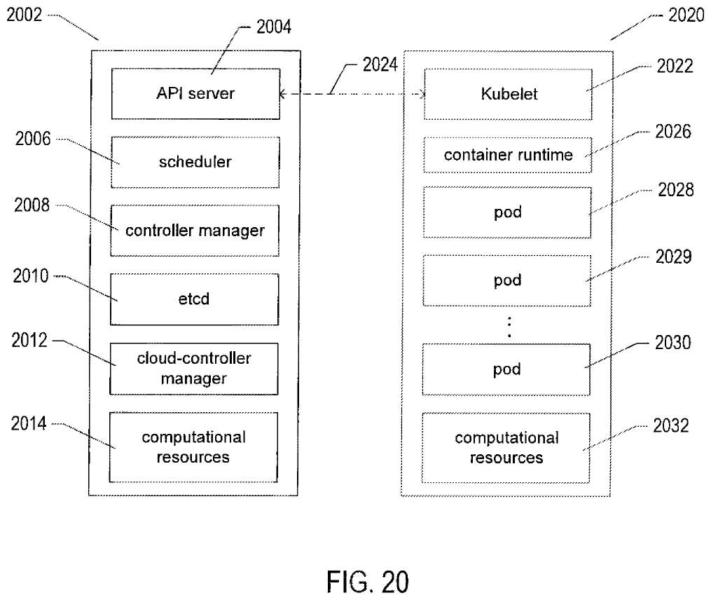

FIG. 20 illustrates the logical contents of a Kubernetes management node and a Kubernetes worker node. A Kubernetes management node 2002 includes an API server 2004 that exposes the Kubernetes API to remote entities and that implements the control-plane front-end. In addition, a Kubernetes management node includes a scheduler 2006 that is responsible for distributing newly created pods among worker nodes, matching pod requirements, constraints, affinities and parameters to the parameters and characteristics of the worker nodes to which a pod is distributed. A Kubernetes management node additionally includes a controller manager 2008 comprising multiple processes that implement multiple controllers, including a node controller, a replication controller, an endpoints controller, and a service-account-and-token controller. Controllers monitor the operational status of pods within the cluster and attempt to ameliorate any detected departures from the specified operational behaviors of the pods. For example, the node controller detects failed nodes and attempt to mitigate node failures. As another example, the replication controller monitors replication objects to ensure that the proper number of pods are running for each replication object. A Kubernetes management node further includes an etcd key-value data store 2010 and a cloud-controller manager 2012, which includes multiple controllers that manage cloud-hosted Kubernetes cluster components. The above-discussed logical components of a master node are implemented above the computational resources 2014 provided by a virtual machine or physical server. A worker node 2020 includes a Kubelet agent 2022 that manages pods running within the worker node in cooperation with the control plate, with which the Kubelet agent communicates via the Kubernetes API, as indicated by dashed arrow 2024. In addition, a worker node includes a container run time 2026, such as the Docker container runtime, and one or more pods 2028-2030 that execute using the computational resources 2032 provided by a virtual machine or physical server.

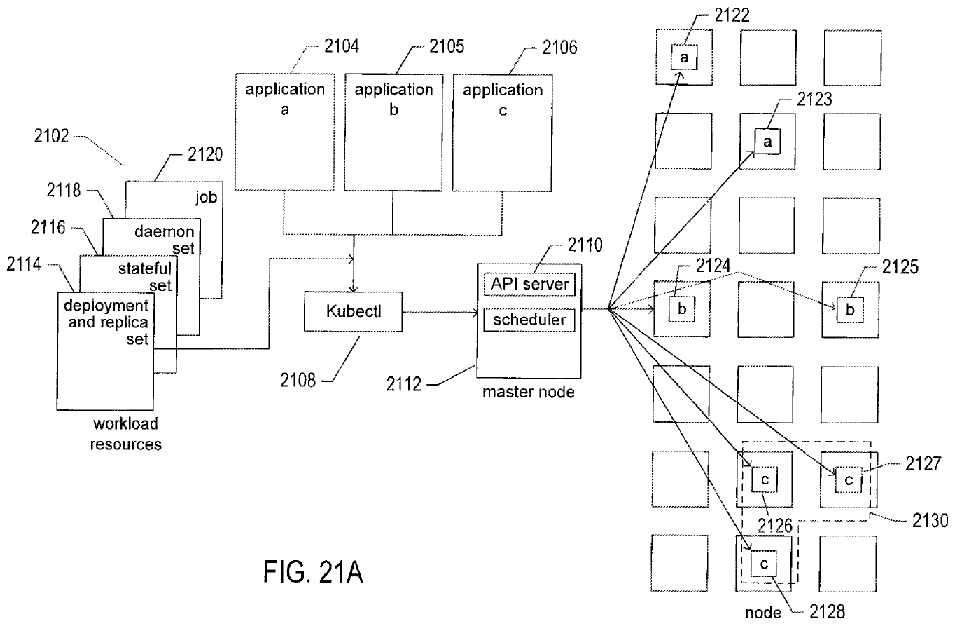

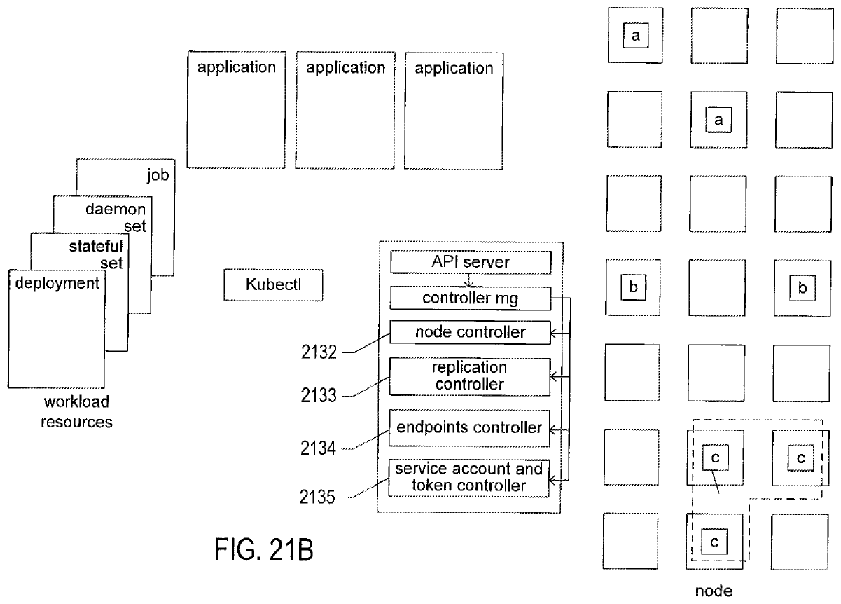

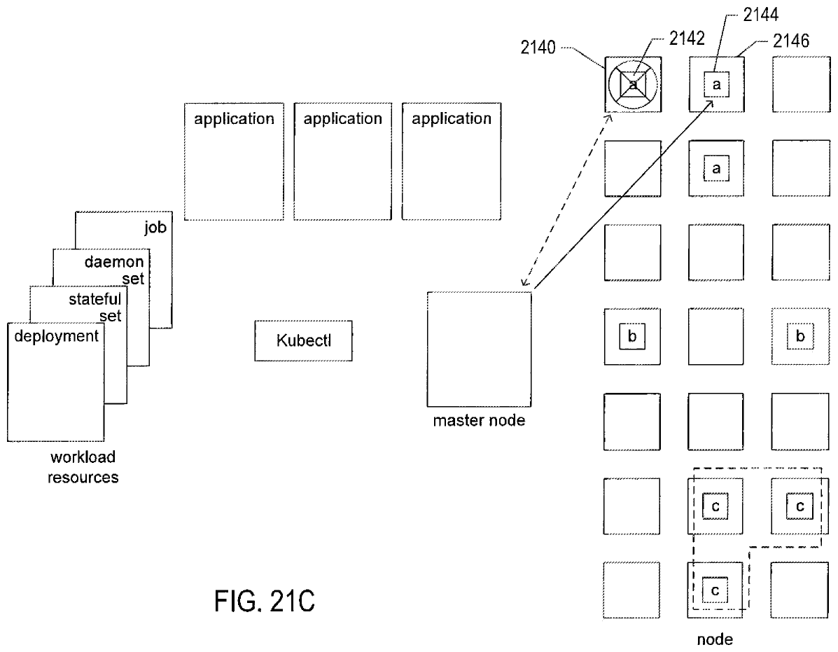

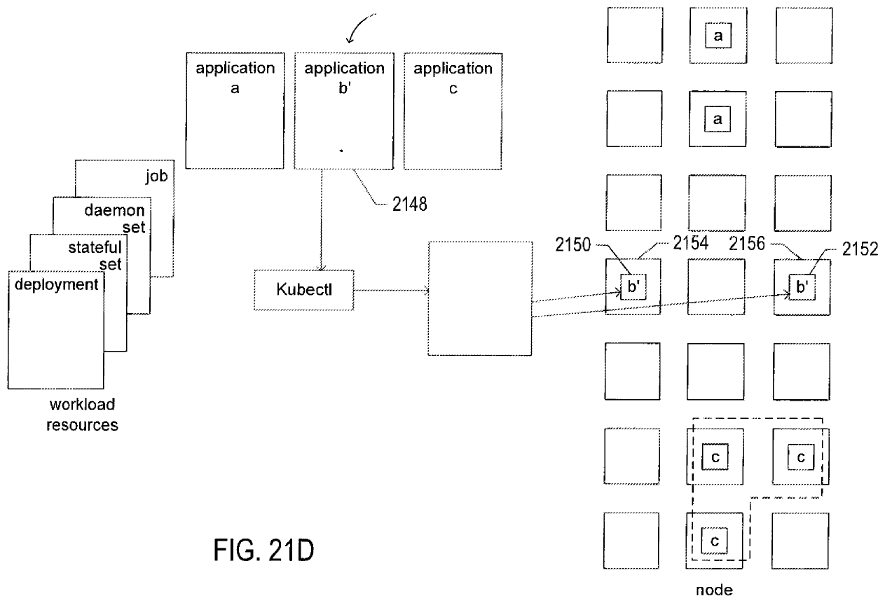

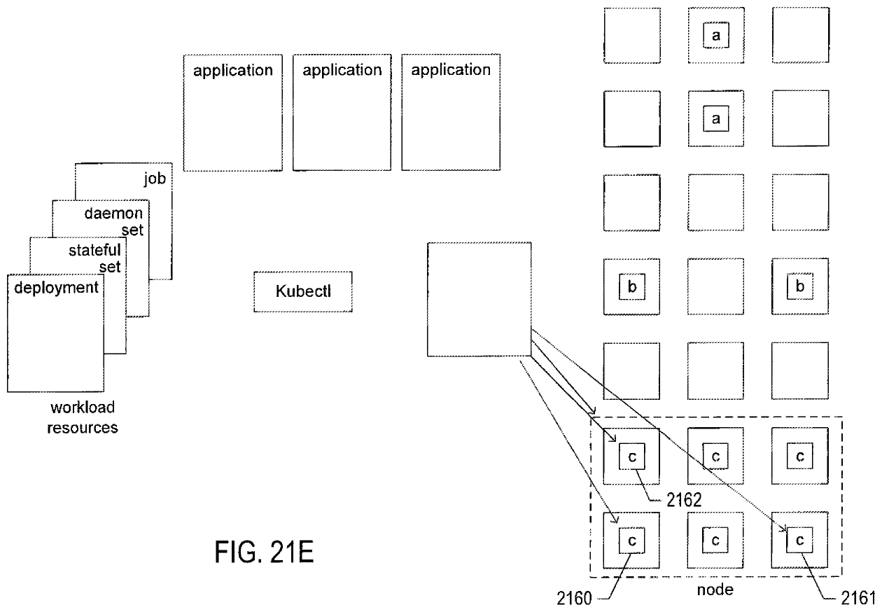

FIGS. 21A-F illustrate operation of a Kubernetes cluster. While there are many ways for a user to access a Kubernetes cluster and Kubernetes-cluster services through the Kubernetes API, a common approach to instantiating containerized applications is to develop a specification, referred to as a “configuration file,” that specifies one or more of various types of workload resources 2102 and to submit the configuration file, along with references to containerized applications 2104-2106, via the Kubectl command line interface 2108 to the Kubernetes API 2110 provided by a Kubernetes-cluster control plane 2112. The Kubernetes-c luster control plane distributes and schedules execution of a set of pods containing containerized-application instances of the containerized applications according to the workload-resource specification. The Kubernetes-cluster control plane then monitors the operational behaviors of the distributed pods over an execution lifetime specified in the workload-resource specification. Thus, the Kubernetes cluster automatically instantiates and manages executable instances of supplied containerized applications according to a workload-resource specification.

There are a number of different types of workload resources. A replicaSet workload resource 2114 is often used for instantiating and managing stateless applications. The Kubernetes control plane manages this type of workload resource, in part, by ensuring that a specified number of pods remain operational for each different type of containerized-application instance specified in the deployment. A statefulSet workload resource 2116 can be used to specify instantiation and management of a set of related pods associated with states. Additional types of workload resources include daemonSets 2118 and jobs 2120. In addition, Kubernetes supports specifying a service abstraction layer that includes a logical set of pods that are exposed to external communications and provided with service-related functionalities, including load-balancing and service discovery.

When, in the example shown in FIGS. 21A-F, the configuration file is input to a Kubernetes system via the Kubectl command line interface 2108, the active master node of the control plane invokes the scheduler to create and distribute pods containing the specified number of containerized-application instances among worker nodes of the cluster as well as to provide additional facilities for sets of pods defined to compose a service. In the example shown in FIG. 21A, two pods containing instances of application a 2122-2123, two pods containing instances of application b 2124-2125, and three pods containing instances of application c 2126-2128, which together compose a service, as indicated by dashed contour 2130, are created according to the input configuration file. As shown in FIG. 21B, the Kubernetes control plate then invokes the controller manager to launch controllers 2132-2135 to monitor operation of the distributed pods which, in turn, launch execution of the containerized applications within the pods according to specifications contained in the configuration file.

FIGS. 21C-E illustrate various types of management operations carried out by the Kubernetes control plate during the lifetime of the workload resources instantiated in FIGS. 21A-B. As shown in FIG. 21C, when a node 2140 that originally hosted an instance of application a fails, as indicated by the “X” symbol 2142, a controller within the Kubernetes control plane detects the failure, after which the Kubernetes control plane creates a new pod to execute an instance of application a 2144 and distributes the new pod to a different, functioning node 2146. As shown in FIG. 21D, when a user supplies a reference to a new version of application b 2148 to the Kubernetes control plane via the Kubectl command line interface 2108, the Kubernetes control plate arranges for two replacement pods 2150 and 2152 containing instances of the new version of application b to be distributed to nodes 2154 and 2156, following which the original pods containing the older version of application b are terminated. As shown in FIG. 21E, when the Kubernetes control plane determines that the current workload associated with the service comprising three pods containing instances of application c (2130 in FIG. 21A) has increased above a specified threshold workload, the Kubernetes control plane automatically scales up this service to include three new pods 2160-2162 to which portions of the excessively high workload can be distributed. Detecting and ameliorating node failures, carrying out updates and upgrades of executing containerized applications, and automatically scaling up and scaling down a deployed workload resource are examples of the many different types of management services and operations provided by a Kubernetes cluster via a set of controllers running within the active management node. Controllers monitor pod operations for occurrences of various types of events and invoke event handlers to handle the events, with each different type of controller monitoring and handling different types of events. The control plane thus dynamically controls the worker nodes in accordance with the configuration file or files that define the configuration and operational behaviors of each workload resource.

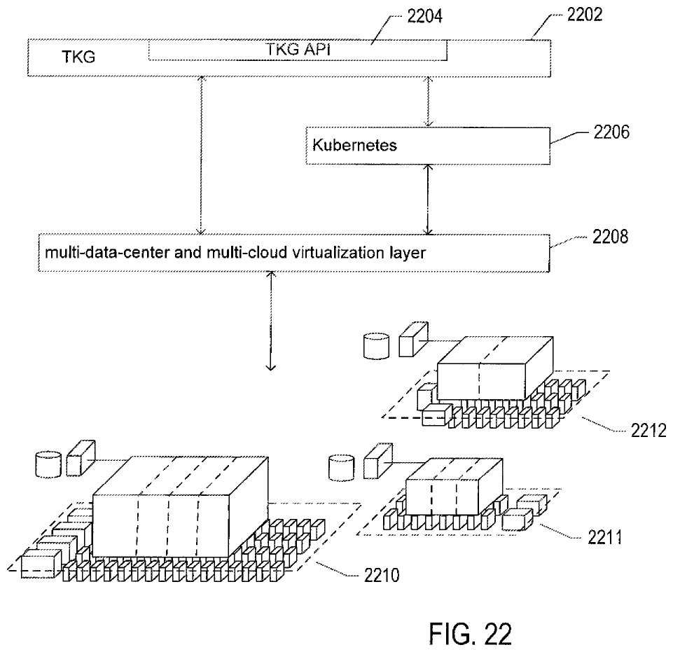

FIG. 22 illustrates the Tanzu Kubernetes Grid (“TKG”) containerized-application automated orchestration system. TKG is a higher-level automated orchestration system that automatically instantiates and manages Kubernetes clusters across multiple data centers and clouds. TKG 2202 provides, through a TKG API 2304, similar services and functionality to those provided by Kubernetes. In fact. TKG is layered on top of Kubernetes 2206. However, TKG is also layered above the multi-data-center and multi-cloud virtualization layer 2208, such as the multi-cloud aggregation distributed system discussed above with reference to FIG. 10. This allows TKG to support Kubernetes-like clusters across multiple data centers and cloud-computing facilities 2210-2212. This also allows TKG to migrate nodes among different data centers and cloud-computing facilities and provide additional functionalities that are possible because of TKG's access to services and functionalities provided by the multi-data-center and multi-cloud virtualization layer. In essence, TKG is a meta-level Kubernetes system. Like Kubernetes. TKG uses both a control plane comprising specialized control-plane nodes as well as a set of worker Kubernetes clusters across which TKG distributes workload resources.

Kubernetes and TKG provide for user-defined operators to extend Kubernetes and TKG functionalities and custom-resource definitions custom resources that extend the types of workload resources that can be specified by workload-resource specifications. Operators are associated with one or more controllers, such as controllers 2132-2135 discussed above with reference to FIG. 21B. The controllers associated with user-defined operators thus extend the types of monitoring and management functionality provided by standard Kubernetes and TKG implementations. User-defines operators may be defined to handle custom resources defined by custom-resource definitions.

### Graphics Processing Units and Passthroughs

FIG. 23 illustrates the nature of certain application dependencies. The outer rectangle 2302 in FIG. 23 represents a server or other physical computer system that includes a hardware layer 2304, a firmware level 2306, a virtualization layer 2308, a guest-operating-system layer 2310, and an application layer 2312. The application layer and guest-operating-system layer together represent an application-execution environment provided by a virtual machine, as discussed in preceding subsections. Execution of a particular containerized-application instance 2314 may require post-deployment installation of a particular plug-in 2316 to extend the functionality of the application instance. In addition, proper execution of the application may depend on the guest operating system including one or more specific operating-system features 2318 and/or a particular configuration of the guest operating system via parameter settings 2320 or other types of customizations. Similarly, proper execution of the application may depend on particular virtualization-layer features 2322 and/or configurations 2324 as well as firmware configurations 2326, such as a specific basic input-output system (“BIOS”) configuration. Finally, proper execution of the application instance may require particular hardware components and features 2328, such as field programmable gate arrays (“FPGAs”), graphical processing units (“GPUs”), application-specific integrated circuits (“ASICs”), and precision-time-protocol (“PTP”) real-time clocks, and may also require virtualization-layer pass-throughs 2330 that allow exclusive access by the guest operating system to particular hardware components 2332. Thus, an application instance may have many different dependencies on guest-operating-system features, virtualization-layer features, firmware configurations, and hardware components and features.

In an example used to illustrate the currently disclosed methods and systems, many machine-learning-based applications are dependent on access to GPUs or ASICs, which represent an important class of hardware dependencies, and may also be dependent on various additional features and components of the virtualization layer and guest operating systems. These types of dependencies are generally not considered and supported by many widely used automated orchestration systems, such as Kubernetes and TKG, and may also prevent various virtualization-layer features and facilities from being applied to applications with such dependencies, including, for example, live migration of virtual machines running applications that use pass-throughs for exclusive access of GPUs and/or ASICs.

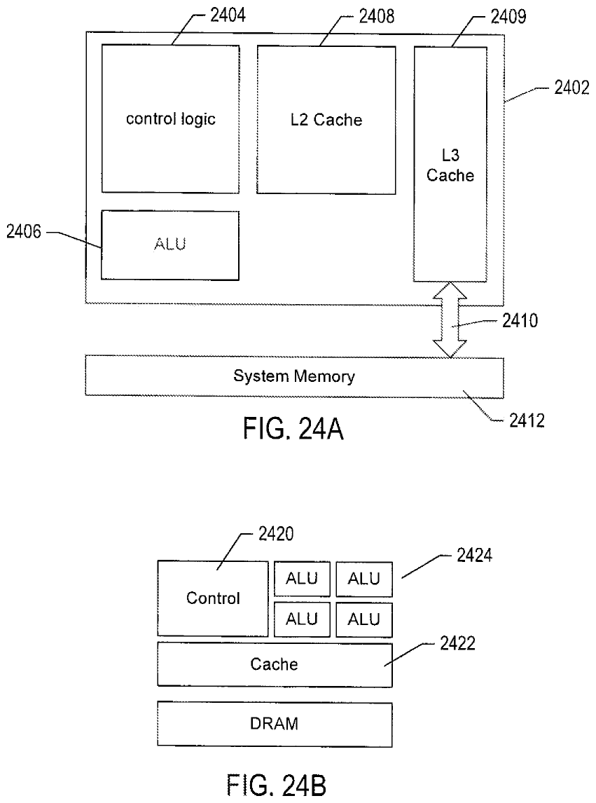

FIGS. 24A-B illustrate general characteristics of a typical central processing unit (“CPU”). As shown in FIG. 24A, a typical CPU 2402 includes complex control logic 2404, a modest number of complex arithmetic and logic units (“ALUs”) 2406, and multiple levels of memory cache 2408-2409. Modern CPUs generally include multiple cores that share access to a higher-level cache, such as the L3 cache 2402, and to communication links, such as a high-speed interconnect 2410 that connects the L3 cache to system memory 2412. As shown in FIG. 24B, the bulk of the integrated-circuit real estate in a CPU is taken up by the control logic 2420 and memory cache 2422, with a comparatively modest amount of integrated-circuit real estate devoted to the modest number of complex ALUs 2424. The CPU control logic is based on complex instruction sets and implements complex logical support for pipelined complex-instruction execution. While modern CPUs do provide for parallel execution of several different instruction sequences, they are largely designed and optimized for sequential execution of large sets of sequentially ordered complex instructions corresponding to high-level program constructs, such as routines and functions.

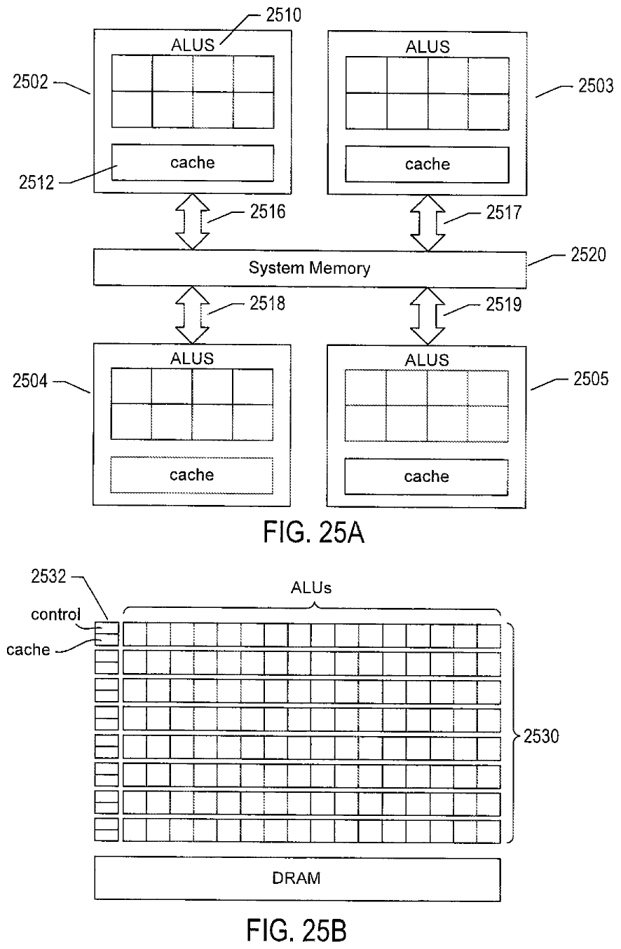

FIGS. 25A-B illustrate general characteristics of a typical GPU. As shown in FIG. 25A, a typical GPU includes multiple cores 2502-2505, each comprising a large number of relatively simple ALUs and a relatively small cache, such as ALUs 2510 and cache 2512 in core 2502. The GPU supports parallel, high-bandwidth interconnects 2516-2519 to an on-board system memory 2522 to provide a high rate of parallel memory access to the large number of ALUs. This allows the ALUs to carry out, in parallel, a large number of specific types of arithmetic and logical operations. GPUs were originally developed as accelerators for rendering graphics data for display. Many display operations involve large numbers of relatively independent, simple operations, such as rendering polygons and rotation and translation of polygon vertices into different coordinate systems. However, the massively parallel computational bandwidths provided by GPUs are now routinely exploited for more general-purpose computations, including various types of mathematical operations, such as matrix operations, that consume significant portions of the computational bandwidths used by modern scientific and artificial-intelligence applications. General-purpose use of GPUs is facilitated by various types of programming models for GPU computing, such as OpenCL. As shown in FIG. 25B, a typical GPU devotes a comparatively large portion of the integrated-circuit real estate to ALUs 2530 and only a relatively small portion of the integrated-circuit real estate to control logic and cache, shown in column 2532 in FIG. 25B.

### GPU-Assisted Neural Network Training

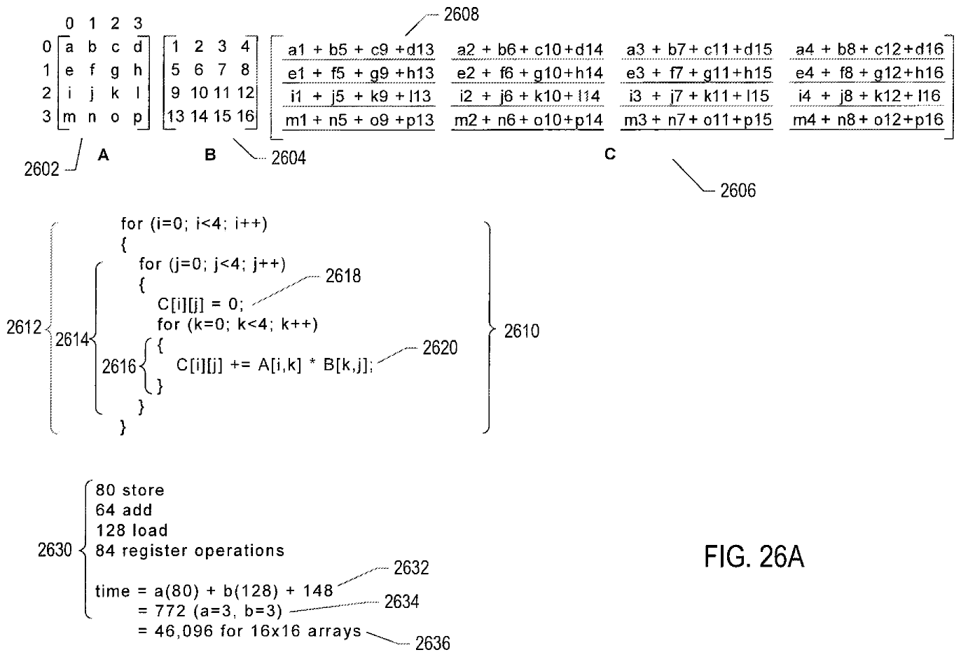

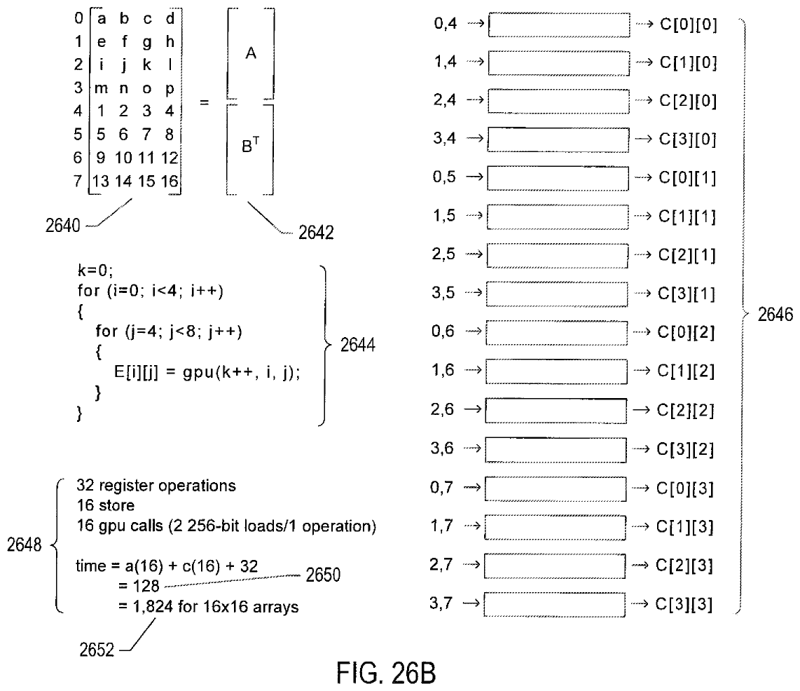

FIGS. 26A-B provide an example of the increase in speed of a simple matrix operation obtained by use of a GPU to accelerate component arithmetic operations. A matrix multiplication of a matrix A 2602 by a matrix B 2604 to produce a resultant matrix C 2606 is shown symbolically at the top of FIG. 26A. In general, the elements of the matrices are real-valued or complex-valued numbers, but, for simplicity, they are represented symbolically by single lower-case characters, in the case of matrix A. and small integers, in the case of matrix B. Thus, for example, the first element 2608 in the resultant matrix C 2606 is the sum of four products, (a*1)+(b*5)+(c*9)+(d*13), where a, b, c, d, 1, 5, 9, and 13 represent real numbers, in the current example. A matrix comprises a set of ordered rows and ordered columns, with indices for the rows and columns indicated for matrix A 2602 in FIG. 26A. It is common, in computing, for the first row and column to have index 0, while in mathematics, the first row and column of a matrix generally have index 1.

A short portion of a routine 2610 that carries out multiplication of matrices A and B is shown in the middle of FIG. 26A. This is a relatively naïve approach to matrix multiplication, but well illustrates the number of operations needed for a sequentially programmed matrix operation. In the routine, loop variable i traverses the row indexes of the matrices and loop variable j traverses the column indexes of the matrices. Loop variable k traverses the indices within a particular row-and-column pair. The outer for-loop 2612 considers each row of the resultant matrix C and matrix A. An inner for-loop 2614 considers each column of the resultant matrix C and matrix B. An innermost for-loop 2616 generates a sum of four products of elements from a currently considered row of matrix A and a currently considered column of matrix B. For each different row and column pair i/j, the statement 2618 sets the corresponding element of the resultant matrix C to 0 and statement 2620 computes a product of an element selected from the currently considered row of matrix A and an element from the currently considered column of matrix B and adds the product to the currently considered element matrix C. As shown in a lower portion of FIG. 26A, execution of the routine portion 2610 to multiply matrices A and B involves 80 memory-store operations, 64 binary register additions, 128 load operations, and 84 unary register operations. Thus, the time, in processor cycles, needed to carry out the matrix multiplication is shown by expression 2632, where a is a constant that indicates the time, in processor cycles, needed for a store instruction relative to the time for a single register operation and b is a constant that indicates the time, in processor cycles, needed for a load instruction relative to the time for single register operation. Assuming that a=b=3, the total time needed for the matrix operation is 772 (2634 in FIG. 26A). For a 16×16 array multiplication, the time would jump to 46,096 (2636 in FIG. 26A). Clearly, the time taken for the matrix multiplication of matrices A and B by the routine fragment 2610 is proportional to the matrix dimension 4 raised to the third power.

FIG. 26B illustrates the same matrix multiplication discussed above, with reference to FIG. 26A, carried out using GPU acceleration. In this approach, the elements of matrices A and B are stored in memory as indicated in diagram 2640, with the rows of matrix A followed by the rows of the transpose of matrix B, as shown in diagram 2642. Routine 2644 is used to carry out the GPU-accelerated matrix multiplication. In this case, the computation carried out by statement 2618 and the innermost for-loop 2616 in routine 2610 shown in FIG. 26 A is instead carried out by 16 parallel operations performed by the GPU, indicated by the column of operations 2646 on the right-hand side of FIG. 26B. As indicated in the lower portion 2648 of FIG. 26B, the time for the GPU-accelerated matrix multiplication is only 128 (2650 in FIG. 26B) and, for a 16×16 array multiplication, only 1,824 (2652 in FIG. 268). The time taken by the GPU to compute the matrix elements is not considered, since the GPU calculations are assumed to occur in parallel to execution of the routine portion 2644 by a CPU. Clearly, GPU acceleration provides a vast increase in speed for the matrix multiplication in this example. For larger matrices, the acceleration may be less spectacular, but still significant, on the order of the reciprocal of the number of parallel operations performed by the GPU.

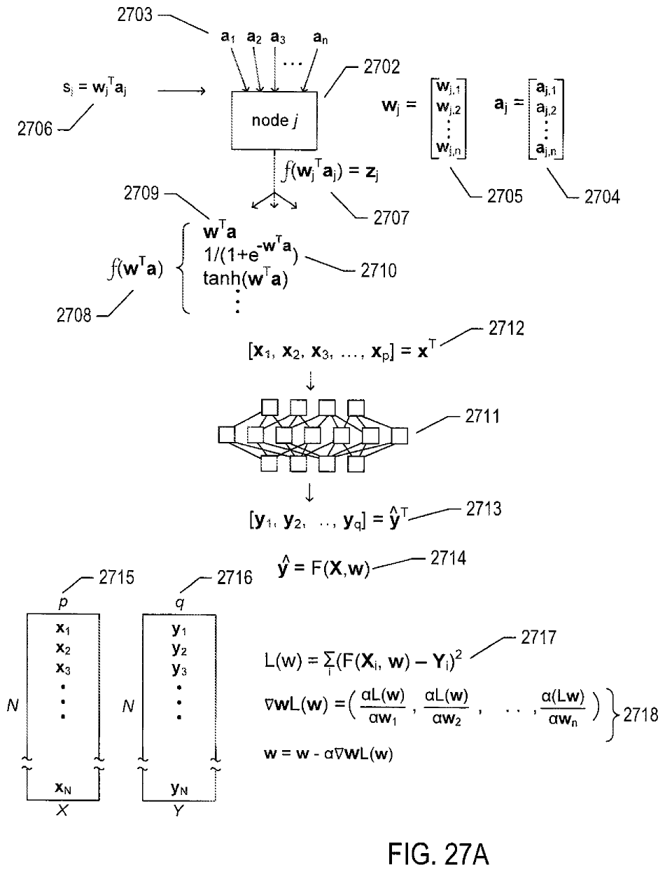

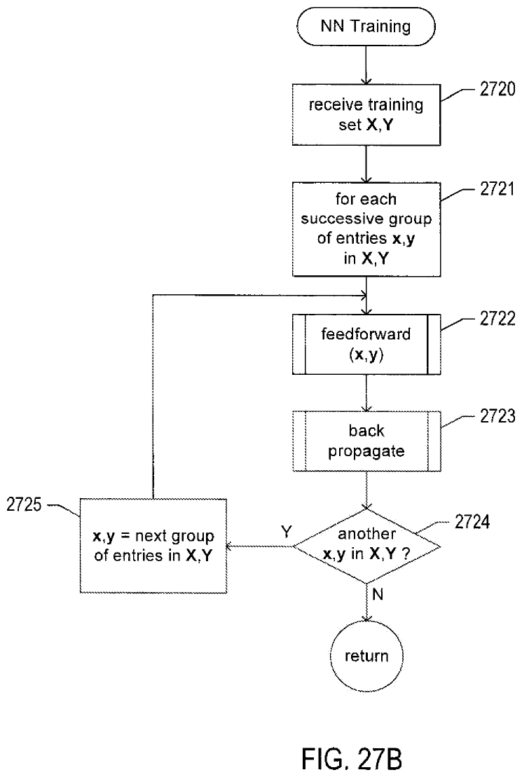

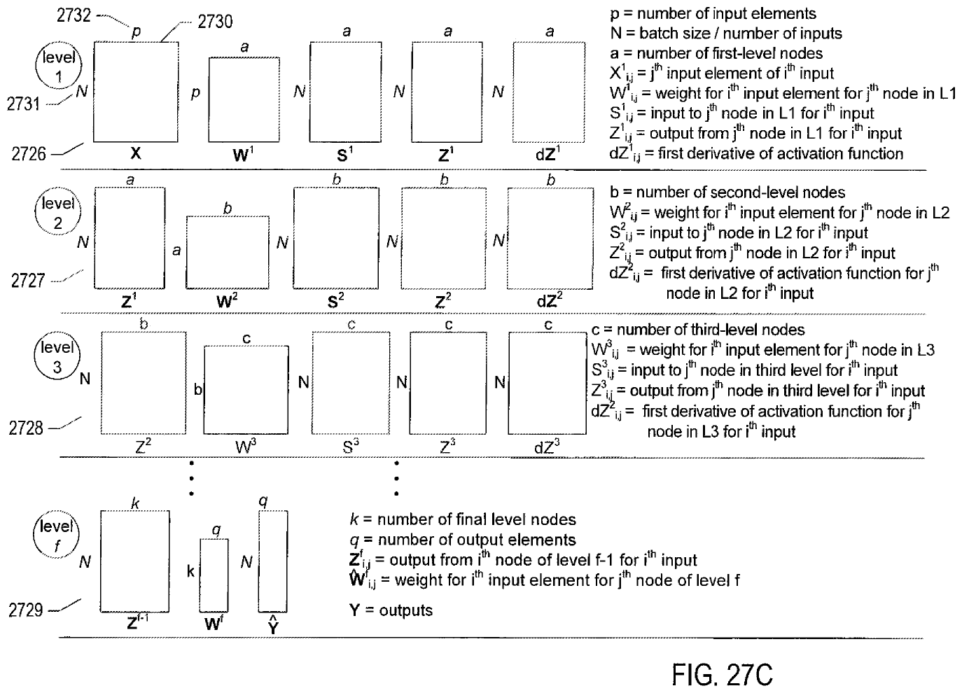

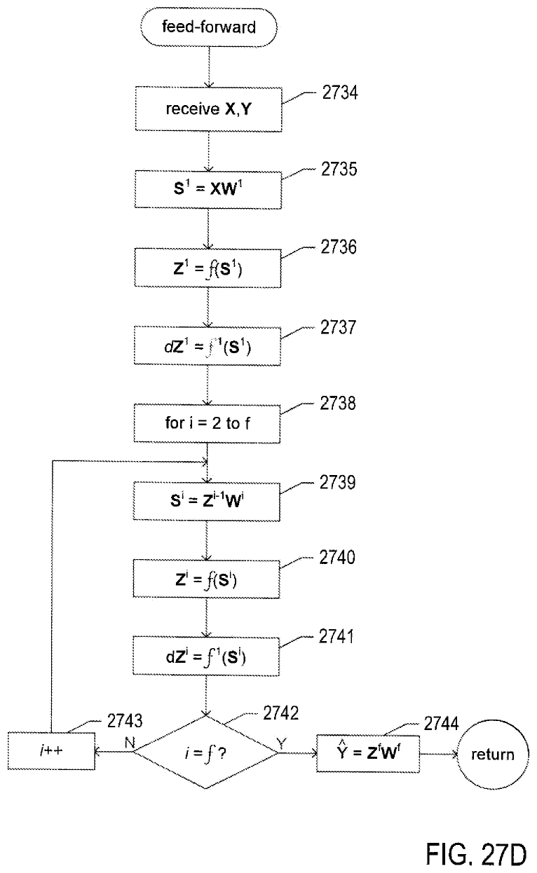

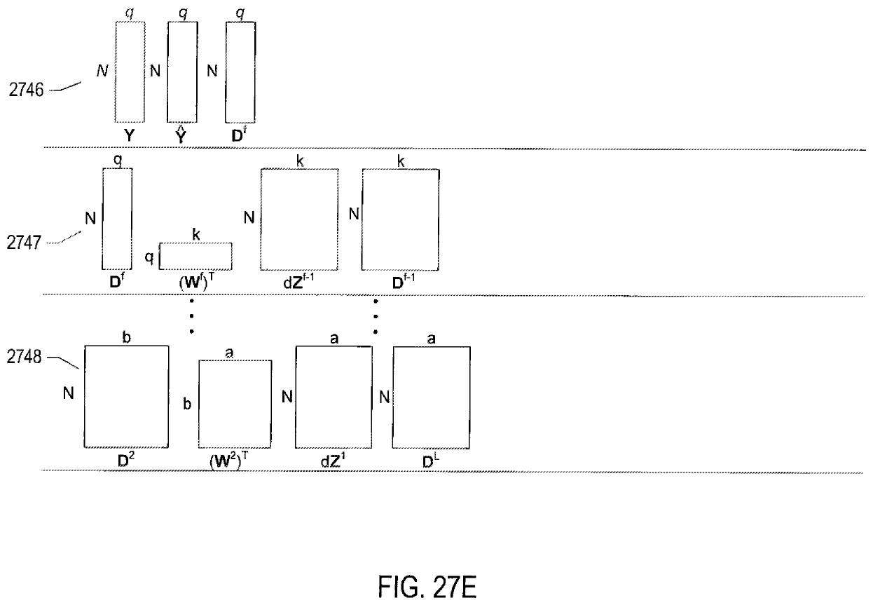

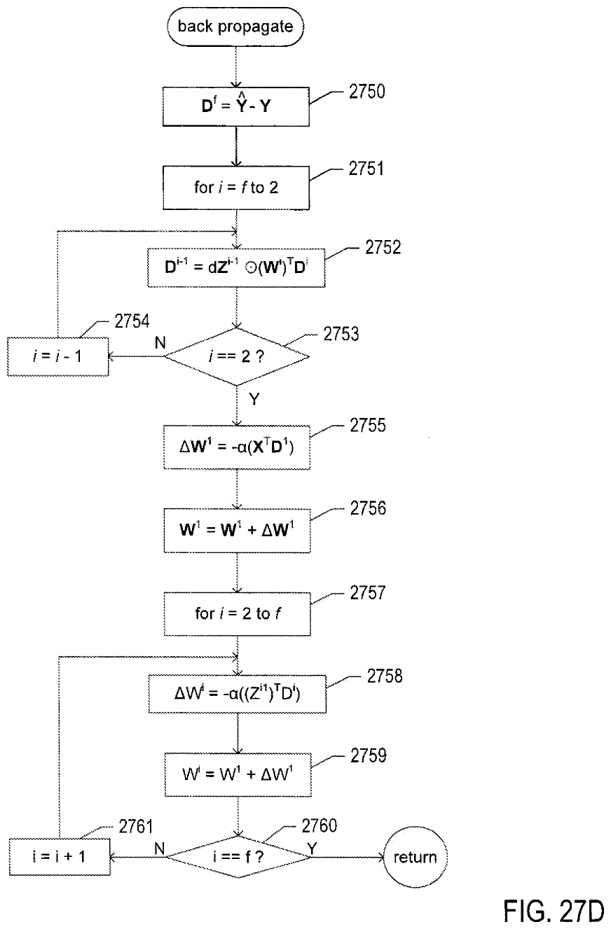

FIGS. 27A-F illustrate a matrix-operation-based method for neural-network training that allows for straightforward CPU acceleration. FIG. 27A illustrates the neural network and associated terminology. As discussed above, each node in the neural network, such as node j 2702, receives one or more inputs a 2703, expressed as a vector 2704, that are multiplied by corresponding weights, expressed as a vector wⱼ 2705, and added together to produce an input signal sᵢ using a vector dot-product operation 2706. An activation function ƒ within the node receives the input signal sᵢ and generates an output signal zⱼ 2707 that is output to all child nodes of node j. Expression 2708 provides an example of various different types of activation functions that may be used in the neural network. These include a linear activation function 2709 and a sigmoidal activation function 2710. As discussed above, the neural network 2711 receives a vector of p input values 2712 and outputs a vector of q output values 2713. In other words, the neural network can be thought of as a function F 2714 that receives a vector of input values x^{T} and uses a current set of weights w within the nodes of the neural network to produce a vector of output values ŷ^{T}. The neural network is trained using a training data set comprising a matrix X 2715 of input values, each of N rows in the matrix corresponding to an input vector x^{T}, and a matrix Y 2716 of desired output values, or labels, each of N rows in the matrix corresponding to a desired output-value vector y^{T}. A least-squares loss function is used in training 2717 with the weights updated using a gradient vector generated from the loss function, as indicated in expressions 2718, where α is a constant that corresponds to a learning rate.

FIG. 278 provides a control-flow diagram illustrating the method of neural-network training. In step 2720, the routine “NNTraining” receives the training set comprising matrices X and Y. Then, in the for-loop of steps 2721-2725, the routine “NNTraining” processes successive groups or batches of entries x and y selected from the training set. In step 2722, the routine “NNTraining” calls a routine “feedforward” to process the current batch of entries to generate outputs and, in step 2723, calls a routine “back propagated” to propagate errors back through the neural network in order to adjust the weights associated with each node.

FIG. 27C illustrates various matrices used in the routine “feedforward.” FIG. 27C is divided horizontally into four regions 2726-2729. Region 2726 approximately corresponds to the input level, regions 2727-2728 approximately correspond to hidden-node levels, and region 2729 approximately corresponds to the final output level. The various matrices are represented, in FIG. 27C, as rectangles, such as rectangle 2730 representing the input matrix X. The row and column dimensions of each matrix are indicated, such as the row dimension N 2731 and the column dimension p 2732 for input matrix X 2730. In the right-hand portion of each region in FIG. 27C, descriptions of the matrix-dimension values and matrix elements are provided. In short, the matrices W^{N} represent the weights associated with the nodes at level x, the matrices S^{N} represent the input signals associated with the nodes at level x, the matrices Z^{N} represent the outputs from the nodes at level x, and the matrices dZ^{N} represent the first derivative of the activation function for the nodes at level x evaluated for the input signals.

FIG. 27D provides a control-flow diagram for the routine “feedforward,” called in step 2722 of FIG. 27B. In step 2734, the routine “feedforward” receives a set of training data x and y selected from the training-data matrices X and Y. In step 2735, the routine “feedforward” computes the input signals S^{l} for the first layer of nodes by matrix multiplication of matrices x and W^{l}, where matrix W^{l} contains the weights associated with the first-layer nodes. In step 2736, the routine “feedforward” computes the output signals Z^{l} for the first-layer nodes by applying a vector-based activation function ƒ to the input signals S^{l}. In step 2737, the routine “feedforward” computes the values of the derivatives of the activation function ƒ′, dZ^{l}. Then, in the tor-loop of steps 2738-2743, the routine “feedforward” computes the input signals S′, the output signals Z′, and the derivatives of the activation function dZ′ for the nodes of the remaining levels of the neural network. Following completion of the for-loop of steps 2738-2743, the routine “feedforward” computes the output values ŷ^{T} for the received set of training data.

FIG. 27E illustrates various matrices used in the routine “back propagate.” FIG. 27E uses similar illustration conventions as used in FIG. 27C, and is also divided horizontally into horizontal regions 2746-2748. Region 2746 approximately corresponds to the output level, region 2747 approximately correspond to hidden-node levels, and region 2748 approximately corresponds to the first node level. The only new type of matrix shown in FIG. 27E are the matrices D^{x} for node levels x. These matrices contain the error signals that are used to adjust the weights of the nodes.

FIG. 27F provides a control-flow diagram for the routine “back propagate.” In step 2750, the routine “back propagate” computes the first error-signal matrix D^{f} as the difference between the values ŷ output during a previous execution of the routine “feedforward” and the desired output values from the training set y. Then, in a for-loop of steps 2751-2754, the routine “back propagate” computes the remaining error-signal matrices for each of the node levels up to the first node level as the Shur product of the dZ matrix and the product of the transpose of the W matrix and the error-signal matrix for the next lower node level. In step 2755, the routine “back propagate” computes weight adjustments ΔW for the first-level nodes as the negative of the constant α times the product of the transpose of the input-value matrix and the error-signal matrix. In step 2756, the first-node-level weights are adjusted by adding the current W matrix and the weight-adjustments matrix ΔW. Then, in the for-loop of steps 2757-2761, the weights of the remaining node levels are similarly adjusted.

Thus, as shown in FIGS. 27A-F, neural-network training can be conducted as a series of simple matrix operations, including matrix multiplications, matrix transpose operations, matrix addition, and the Shur product. Interestingly, there are no matrix inversions or other complex matrix operations needed for neural-network training. The simple matrix operations are thus the easily accelerated by use of a GPU, as discussed above with respect to FIGS. 26A-B. Thus, many neural-network-based applications employ GPU acceleration to greatly decrease the wall-clock time and the CPU computational bandwidth needed for neural-network training. Other types of machine-learning-based applications that use other types of machine-learning methods also rely on GPU acceleration or other types of hardware acceleration, including ASIC accelerators, such as the Tensor processing unit (“TPU”).

### Problems with Traditional Approaches to Deployment of Applications with Hardware Dependencies

When users employ automated orchestration systems to deploy applications, such as Kubernetes and TKG, discussed above with reference to FIGS. 17-22, users prepare a workload-resource specification for a distributed application that specifies the various different types of constraints, requirements, and dependencies for each of the different types of distributed-application instances, along with providing references to executables and other information needed by the automated orchestration system to deploy and launch application instances. Users then submit the workload-resource specification to the automated orchestration system, which then maps the distributed-application instances to candidate nodes that meet the constraints, requirements and dependencies of the distributed-application instances, deploys the distributed-application instances to nodes selected from the set of candidate nodes, and launches execution of the deployed application instances. The automated orchestration system then manages the distributed application over its lifetime, including restarting instances that were executing on failed nodes, carrying out scaling operations, and carrying out other types of management operations. Unfortunately, many automated orchestration systems are unable to manage workload specifications that specify certain types of hardware dependencies, such as requirements for hardware accelerators that must be accessed via pass-through mechanisms provided by the virtualization layer. In addition, a machine-learning-based application instance may require uninterrupted access to hardware accelerators during entire training phases. These types of application instances are often not developed to be reentrant and thus cannot be restarted following failure of a node or when the node is placed into a maintenance mode by the infrastructure management organization. Because training phases may last for many hours, days, or longer, restarting machine-learning-based applications interrupted by node failures or node maintenance during training phases can represent a huge waste of time and money, since they must be restarted from the beginning of the training phase that was interrupted. Automated orchestration systems currently do not have the ability to select candidate nodes that are not scheduled for maintenance during the time needed by machine-learning-based applications to complete training phases. In many cases, there is not even a reasonable manual approach for users to manually deploy machine-learning-based applications in order to avoid training-phase failures due to maintenance operations conducted by the infrastructure-management organization.

FIGS. 28A-F illustrate one problem domain specifically addressed by the currently disclosed methods and systems. As shown in FIG. 28A, this problem domain involves a distributed computer system 2802 represented by a portion of a dashed-line rectangle within which a number of computational nodes are represented by smaller rectangles, such as rectangle 2804. The computational nodes may be physical servers, virtual machines, or other computational entities that support execution of application instances. Ellipses, such as ellipsis 2806, indicate that the distributed computer system includes many additional computational modes. The distributed computer system provides a platform for execution of user applications, and the viewpoints of users whose machine-learning-based applications run on a distributed computer system represent a first perspective or vantage point 2808. The system-management personnel and/or management organization that manages and maintains the distributed-computer-system infrastructure represents a second perspective or vantage point 2810. FIG. 28B shows aspects of the distributed computer system common to both the user and the system-management perspectives. In both perspectives, the nodes have configurational and operational characteristics that can be determined by human users and human managers as well as, in many cases, by automated systems, such as automated orchestration systems and automated system-management tools. The configurational and operational characteristics include access to GPUs and other types of hardware accelerators provided by nodes 2812-2814 and current available computational-support capacities within the nodes, such as memory capacity, processor bandwidth, networking bandwidth, mass-storage capacity, and other such capacities, collectively represented by dashed-lined rectangles, such as dashed-line rectangle 2816, in each of the nodes. The larger the area of the dashed-line rectangles, the greater the current available capacity for executing application instances.

FIG. 28C illustrates information about the distributed computer system that is available to system-management personnel, and thus part of the system-management perspective, but that is generally not available to users. This information is represented by horizontal timelines, such as horizontal timeline 2818, below each node. A shaded rectangle located on the timeline 2020 represents a time interval during which maintenance has been scheduled for the node. The timeline begins with the current time 2822 and extends forward in time. Thus, the timelines each represents a maintenance schedule for the nodes of the distributed computer system. As discussed above, the maintenance schedule is of critical importance to users wishing to deploy machine-learning-based application instances that need to run to completion in order to train machine-learning entities, such as neural networks. Thus, for example, were a user aware of the maintenance schedule 2824 for computational node 2826, and the user needed to deploy a machine-learning-based application instance with an upcoming training phase, the user would not select computational node 2826 for deployment of the machine-learning-based application instance. While it is possible for users to ask for maintenance-schedule information in order to make informed node-selection decisions, it is generally inconvenient, error-prone, and unacceptably time-consuming for users to be required to do so.

FIG. 28D illustrates information that is available to users but not to system-management personnel. This information includes the training-phase schedule 2828 for a machine-learning-based application instance, where the expected time period for the training phase is represented by a crosshatched block 2830 superimposed on the training-phase-schedule timeline representation. The information also includes a Boolean indication of whether or not a GPU accelerator is needed for the application instance 2832 and various additional system requirements, configurations, capacities, and features needed for execution of the machine-learning-based application instance 2834. It should be noted that this information may differ in different implementations. For example, in certain implementations, rather than a Boolean indication of whether or not a GPU accelerator is needed, a list of different types of needed hardware accelerators may instead be provided, since an application may be specifically written to use particular types of GPUS Were system-management personnel aware of this type of information, following deployment of a machine-learning-based-application instance, system management might be able to defer maintenance operations that would occur during the training phase of the machine-learning-based-application instance to allow the training phase to complete, and thus prevent the costs associated with interrupting the training phase and requiring the machine-learning-based-application instance to be restarted. However, there is currently no practical method by which system-management personnel can obtain this information. In addition, were automated orchestration systems aware of this type of information, the automated orchestration systems could rationally select computational nodes for deployment of machine-learning-based application instances. However, in the currently available automated orchestration systems do not support consideration of this type of information when deploying application instances.

FIG. 28E illustrates how the currently disclosed methods and systems address of the problem domain discussed above with reference to FIGS. 28A-D. The currently disclosed methods and systems provide mechanisms that allow system-management personnel to publish maintenance schedules for computational nodes of a distributed computer system 2836-2848, that allow users to publish training-phase projections, that allow automated orchestration systems to access the published maintenance schedules as well as to consider machine-learning-based-application-specific information 2850, discussed above with reference to FIG. 28D, and that allow management personnel to access the published training-phase projections, referred to as training schedules. This allows an automated orchestration system to reject computational nodes as candidates for hosting machine-learning-based-application instances when the characteristics of the computational nodes are not compatible with the requirements and constraints associated with the machine-learning-based-application instances and when the training schedules associated with the machine-learning-based-application instances conflict with the published maintenance schedules. Thus, even though the configurational characteristics of node 2852 meet the requirements and constraints for executing a machine-learning-based application instance 2850, the projected training schedule for the application instance 2854 conflicts with the maintenance schedule 2836, and thus, as indicated by the “X” symbol 2856, the automated orchestration system rejects node 2852 for deployment of the application instance. Similarly, node 2858 is rejected because the current computational capacity 2860 for the node is insufficient for supporting execution of the application instance in view of the computational-capacity requirements 2862 for the application instance. However, node 2864 has both the needed computational capacity, an available GPU, and has a maintenance schedule that does not conflict with the projected training schedule for the application instance, and can therefore be confidently selected for deployment of the application instance by the automated orchestration system. Moreover, once deployed, the system-management personnel can access the published projected training schedule for the application instance in order to defer any maintenance operations that might be considered after the application instance is deployed until the training phase is complete.

FIG. 28F illustrates matching of training schedules to maintenance schedules. In the problem-domain discussion with reference to FIGS. 28A-E, the training and maintenance schedules include only a single training phase and a single maintenance interval, respectively. However, as shown in FIG. 28F, a training schedule 2870 may include multiple training-phase intervals 2872-2874. Furthermore, maintenance schedules, such as maintenance schedule 2876, may include multiple maintenance intervals 2878-2882. Thus, in determining whether or not there are conflicts between a training schedule and a maintenance schedule, the training schedule needs to be superimposed over the maintenance schedules of candidate computational nodes, as shown in the right-hand portion of FIG. 28F 2884, with vertical dashed lines, such as vertical dashed line 2886 showing the training-phase intervals with respect to the maintenance controls. In this case, maintenance schedule 2888 has no conflicts with training schedule 2870 were the application instance associated with the training schedule to begin execution at the current time 2890. There are also no conflicts with training schedule 2891, but in several cases 2892-2893, training intervals and maintenance intervals are adjacent, in time, and therefore provide no leeway should the intervals be displaced in time due to various factors and events. Thus, the node associated with maintenance schedule 2888 is clearly the best candidate node for hosting the application instance associated with training schedule 2870 in the ease that the application instance is immediately launched. Of course, when there is leeway with respect to the time at which the application instance is launched, the training schedule can be accordingly shifted, in time, with respect to the maintenance schedules in order to identify a launch time for which no conflicts would occur. Thus, depending on the implementation, matching of training schedules to maintenance schedules may involve more complex considerations than indicated by the simple training and maintenance schedules shown in FIGS. 28A-E.

### Currently Disclosed Methods and Systems

The currently disclosed methods and systems specifically address the problem domain discussed above with reference to FIGS. 28A-F. However, these methods and systems also address a wider range of problems associated with deploying and managing applications in distributed computer systems. While the following discussion focuses on the specific problem of deploying machine-learning-based application instances through an automated orchestration system, such as Kubernetes or TKG, the currently disclosed methods and systems also provide functionalities and capabilities that can be used for deploying other types of application instances and for managing many different types of distributed applications.

FIGS. 29A-B illustrate two possible approaches to addressing the problem of deploying machine-learning-based application instances on computational nodes of a distributed computer system. In a first approach, shown as a control-flow-diagram fragment in FIG. 29A, a user attempts to cooperate with management personnel to identify an appropriate computational node for deployment of a machine-learning-based-application instance. In FIG. 29A, user-initiated steps are shown in a left-hand portion of the FIG. 2902 and management-personnel-initiated steps are shown in a right-hand portion of the FIG. 2904. In step 2906, the user determines and characterizes a new machine-learning-based workload and then, in step 2907, requests information related to placement of the workload in a distributed computer system based on workload requirements and characteristics by transmitting a request to management personnel. In step 2908, the request is received. In step 2909, the management personnel select candidate hosts on behalf of the user by comparing the training schedule associated with the workload to a maintenance schedule maintained by the management personnel and by comparing other requirements and characteristics of the workload to configurations and capacities of computational nodes. In step 2910, management personnel return the one or more selected candidate hosts to the user, who receives the suggested hosts in step 2911. In the for-loop of steps 2912-2916, the user considers each of the suggested candidates c. In step 2913, the user attempts to deploy the workload on the currently considered candidate c. When deployment fails, as determined in step 2914, and when there is another candidate to consider, as determined in step 2915, c is set to the next candidate and control returns to step 2913. When there are no further candidates, as determined in step 2915, then a handler is called to handle the deployment failure, in step 2917. This may involve again requesting candidate hosts from the management personnel, deferring deployment of the workload, changing a range of acceptable launch times for the workload, and/or other such ameliorative actions. The attempt to deploy the workload on a candidate host, in step 2913, may fail for various reasons. For example, in the time between requesting placement information, in step 2907, and receiving the list of candidate hosts, in step 2911, other users may have successfully deployed applications on one or more of the candidate hosts so that they no longer have configurations and capacities needed for hosting the user's workload. For example, the workload may require exclusive access to a GPU or other accelerator, but that GPU may now be committed to a different application instance. As another example, due to workload fluctuations on the candidate host, the candidate host may have insufficient computational resources, such as available CPU bandwidth, to host the users workload at the current time.

The approach illustrated in FIG. 29A is problematic for a variety of different reasons. One reason is that management personnel do not currently provide candidate-host suggestions to users and generally lack the ability to field and respond to placement-information requests in a timely fashion. The delays between steps 2907 and 2911 may be considerable, and far greater than can be tolerated by users. Another problem, suggested in the preceding paragraph, is that the information needed to make informed host selections for application deployment is not static, but is often instead extremely dynamic. As a result, nodes that appeared to be good candidates for hosting a particular workload at one point in time may no longer be good candidates at the point in time when a workload is to be launched. Similarly, nodes that do not appear to be good candidates for hosting a workload when placement information is requested may have become good candidates at the point in time when a workload is to be launched. Yet another problem is that users generally expect to be able to deploy and launch application instances quickly, using information that can be quickly accessed through information interfaces provided by system-management tools or through automated orchestration systems, such as Kubernetes and TKG, which maintain such information internally. The approach suggested by the control-flow-diagram fragment shown in FIG. 29A is both problematic and, in general, impractical.

FIG. 29B provides a control-flow-diagram fragment that illustrates an approach to addressing the problem of deploying machine-learning-based application instances on a distributed computer system used in the currently disclosed methods and systems. FIG. 29B is divided into three vertical sections 2920-2922. The first section 2920 includes steps initiated by users, the second section 2921 includes steps initiated by an automated orchestration system, and the third portion 2922 includes steps initiated by management personnel. Step 2924 is equivalent to step 2906 in FIG. 29A. In step 2925, a user requests placement of the characterized workload by the automated orchestration system. In step 2926, the automated orchestration system receives the placement request and, in step 2927, selects candidate hosts compatible with the workload requirements and constraints, including the training schedule and requirements for GPUs or other hardware accelerators. The automated orchestration system is able to select candidate hosts compatible with all of the requirements and characteristics of the workload, including the need for a GPU or other hardware accelerators and in view of the training schedule associated with the workload because the automated orchestration system can access centrally managed maintenance and training schedules for computational nodes and application instances and because the automated orchestration system is enhanced, by additional operators, to consider the need for GPUs and other hardware accelerators by a workload and the training schedule associated with the workload. In step 2928, the automated orchestration system deploys the workload on a selected host, reserving the GPU and/or other accelerators for exclusive use by the workload, and then returns an acknowledgment to the user. In step 2929, the user receives the acknowledgment and is confident that the workload has been placed on a node that will allow the workload to execute to completion. Note that there is no need for the user to solicit information from management personnel and that the automated orchestration system maintains sufficient internal information to select an available host computer that is compatible with the deployment request, with very low possibility of dynamic changes in host status rendering the selection unviable. In step 2930, management personnel determine new maintenance intervals and other such information that need to be used to update the maintenance schedule. In step 2931, management personnel transmit the updated information to the centrally managed maintenance schedule. In step 2932, management personnel become aware of the need to place one or more computational nodes into maintenance mode, which results in evicting or terminating application instances executing on those computational nodes, and requests schedule and/or deployment information from the centrally managed maintenance and training schedules. In step 2933, the management personnel receive the schedule and/or deployment information, which allows the management personnel to consider deferring or avoiding placing those computational nodes into maintenance mode that are currently executing machine-learning based application instances that are currently in, or that will soon embark on, training phases and that should therefore not be interrupted. While there may be cases in which management personnel cannot defer or delay unexpected maintenance operations, it is often the case that they can work around training phases of deployed machine-learning-based application instances. The centrally managed maintenance and training schedules provide asynchronous access to maintenance-schedule and training-schedule information by users, automated orchestration systems, and management personnel. This avoids the need for synchronous communications between users and management personnel. In addition, automated management tools can access the training schedule to generate notifications and alerts to inform management personal of impending maintenance mode or termination actions that may result in terminating execution of machine-learning-based application instances which are, or will be, executing training of machine-learning entities.

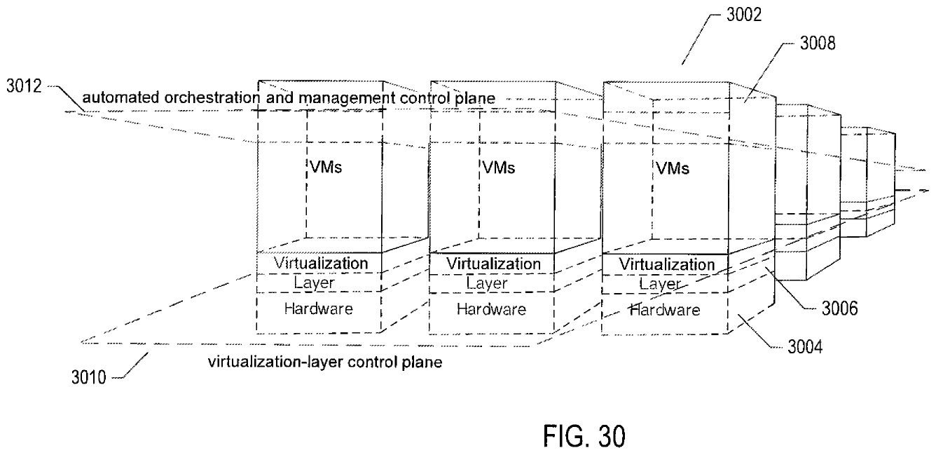

FIG. 30 illustrates two different control planes that provide functionalities used by the currently disclosed methods and systems. FIG. 30 shows a distributed computer system composed of multiple servers, such as server 3002. The servers each includes hardware 3004 and virtualization 3006 layers along with execution environments 3008 for virtual machines, virtual appliances, and other such computational nodes. A first control plane 3010 can be thought of as the individual virtualization layers aggregated together by various levels of virtualization-management systems, such as the multi-cloud aggregation discussed above with reference to FIG. 10. The virtualization-layer control plane 3010 provides a variety of services through one or more application programming interfaces (“API”) and graphical-user-interface (“GUI”) control panels. For example, the virtualization-layer control plane provides services that allow automated management tools and human managers to determine the configurations and operational states of the virtualization layers and servers in which they reside as well as services for launching, migrating, terminating, and monitoring virtual machines executing within the servers. A second control plane 3012 represents an automated orchestration system, such as Kubernetes or TKG, that provides interfaces through which users can deploy distributed-application instances, as discussed above. The currently disclosed methods and systems employ enhancements to both control planes to allow them to cooperate to provide the centrally managed maintenance and training schedules discussed above with reference to FIG. 29B as well as to provide, by the automated-orchestration-and-management control plane, intelligent deployment and management of application instances that require access to GPUs and other hardware accelerators and that are characterized by training-phase intervals during which premature termination of the application instances leads to significant temporal and financial costs to users.

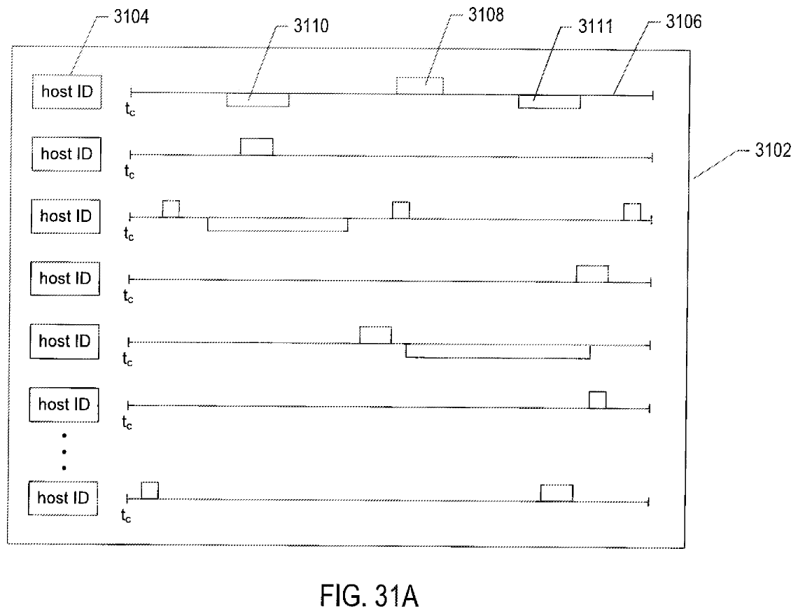

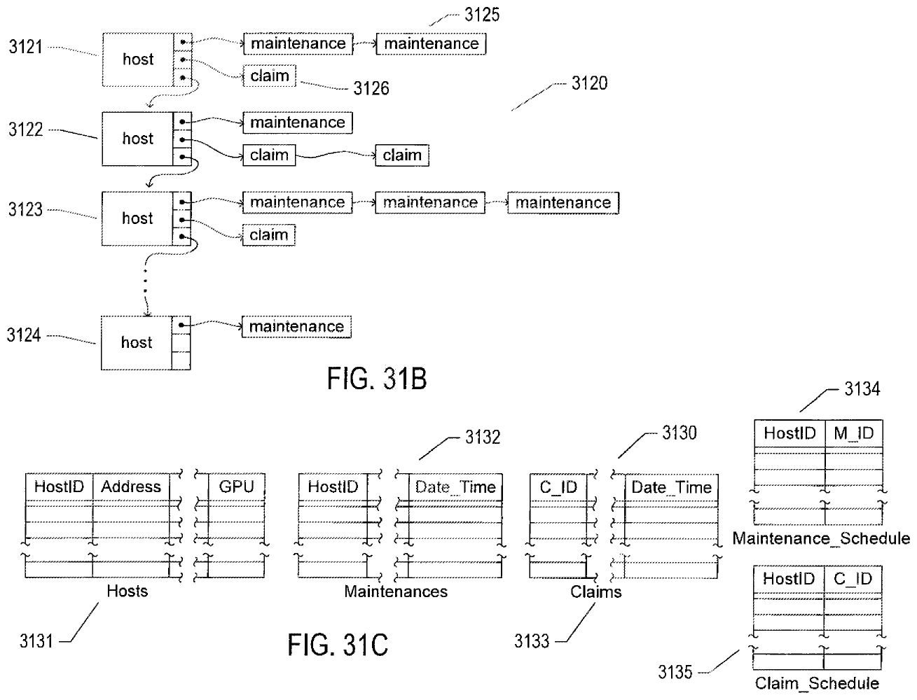

FIGS. 31A-C illustrate a logical, centrally managed maintenance-and-training schedule that provides a basis for the currently disclosed methods and systems. FIG. 31A provides a logical illustration 3102 of centrally managed maintenance and training schedules. In other words, the maintenance and training schedules are logically combined into a single maintenance-and-training schedule. In certain implementations, a single maintenance-and-training schedule may, in fact, be implemented. In other implementations, including an implementation discussed below, the logical maintenance-and-training schedule represents separate maintenance and training schedules that are maintained by different entities.

Each computational node, such as a server running virtualization layer, is represented in FIG. 31A as a rectangle 3104 containing a host identifier. The centrally managed maintenance-and-training schedule includes a maintenance-and-training schedule, represented by a horizontal timeline, such as horizontal timeline 3106, for each computational node. The maintenance-and-training schedule includes indications of time intervals during which maintenance operations are scheduled, such as time interval 3108, and intervals during which training phases are expected for application instances running on the computational nodes, such as intervals 3110 and 3111. A maintenance schedule, in the currently described implementation, is maintained by the virtualization-layer control plane and a training schedule is maintained with an orchestration system. A maintenance-and-training schedule can be implemented in a variety of different ways, including by an in-memory data structure, such as the in-memory data structure 3120 shown in FIG. 31B, or by some type of database within a database-management system, represented by a set of relational-database tables 3130 shown in FIG. 31C. The in-memory data structure 3120 comprises a linked list of host nodes 3121-3124, each of which references a linked-list of scheduled maintenance intervals, such as link list 3125, and a linked list of claims to one or more hardware accelerators, such as link list 3126, which represents a projected training schedule. The various nodes each includes multiple data fields that specify date and time ranges, host identifiers, and other related information. Similarly, the database tables 3130 shown in FIG. 31C alternatively represent the maintenance-and-training schedule by rows in the relational database tables. Each row in the Hosts table 3131 is equivalent to a node in the link list of hosts and FIG. 31 B. Each row in the Maintenances table 3132 is equivalent to a node in the maintenance link list 3125 in FIG. 31B. Each row in the Claims table 3133 is equivalent to a node in a claims linked list 3126 in FIG. 3B. The associations between scheduled maintenance intervals and hosts are represented by entries in the Maintenance_Schedule table 3134 and the associations between claims to accelerators, or training intervals, are represented by entries in the Claim_Schedule table 3135. Of course, many alternative implementations of the centrally managed maintenance-and-training schedule are possible.

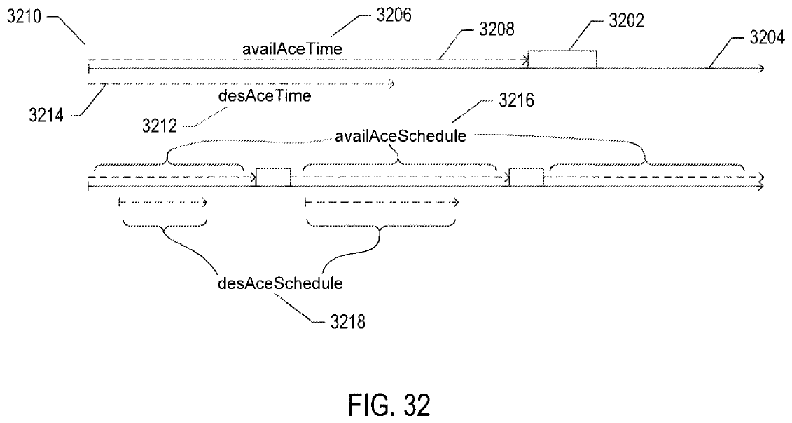

FIG. 32 illustrates two metrics used in the subsequent discussion of one implementation of the currently disclosed methods and systems. A particular maintenance interval 3202 is shown positioned on a horizontal timeline 3204. The metric availAccTime 3206 refers to the time interval, represented by the dashed arrow 3208, between the current time 3210 and the beginning of the maintenance interval 3202. This is the time interval during which a machine-learning-based application instance with training phases may safely execute on a computational node associated with the maintenance schedule represented by the timeline 3204 and maintenance interval 3202. This, of course, assumes that any accelerators required by the machine-learning-based application instance are available for exclusive use by the machine-learning-based application instance until the starting point of the maintenance interval. The metric desAccTime 3212 refers to a time interval, represented by dashed arrow 3214, corresponding to the projected execution time for a particular machine-learning-based application instance that requires one or more hardware accelerators for a training phase, positioned to start at the current time 3210. As discussed above with reference to FIG. 28F, two alternative metrics availAccSchedule 3216 and descAccSchedule 3218 can be alternatively used to describe more complex maintenance-and-training schedules that involve multiple maintenance intervals and/or multiple training phases. Comparison of the available metric to the desired metric can be used to determine whether or not a particular machine-learning-based application instance that requires hardware accelerators can be confidently deployed on a particular computational node to avoid premature termination during a training phase for these more complex cases. For simplicity, in the following discussion, the metrics are generalized as availM and desM, which are compared by a suitable comparison method to determine whether or not the training schedule associated with a machine-learning-based application instance is compatible with the maintenance schedule associated with a computational node regardless of whether the training and maintenance schedules are simple, one-event schedules or more complex multi-event schedules, and regardless of whether additional factors, such as an ability to offset launching of an application instance, are considered in the comparison.

In the following discussion, one implementation of the currently disclosed methods and systems is based on the Kubernetes automated orchestration system and the VMware vCenter Server (“vCenter”) virtualization-layer-management system. However, the currently disclosed methods and systems may be based on alternative automated orchestration systems and virtualization-layer management systems. To enable Kubernetes to process machine-learning-based workloads that require hardware accelerators, such as GPUs, for execution or training phases, an ML custom resource definition (“ML_CRD”) is provided. The ML_CRD allows workload specifications to include a requirement for access to a GPU and/or other hardware accelerator and to specify the desM metric, discussed above. New operators are introduced into Kubernetes to process the ML_CRD workload specifications. In addition, vCenter is enhanced to maintain a maintenance schedule that is accessible to the new Kubernetes operators as well as to maintenance personnel, and to automated tools used by maintenance personnel, to manage distributed computer systems.

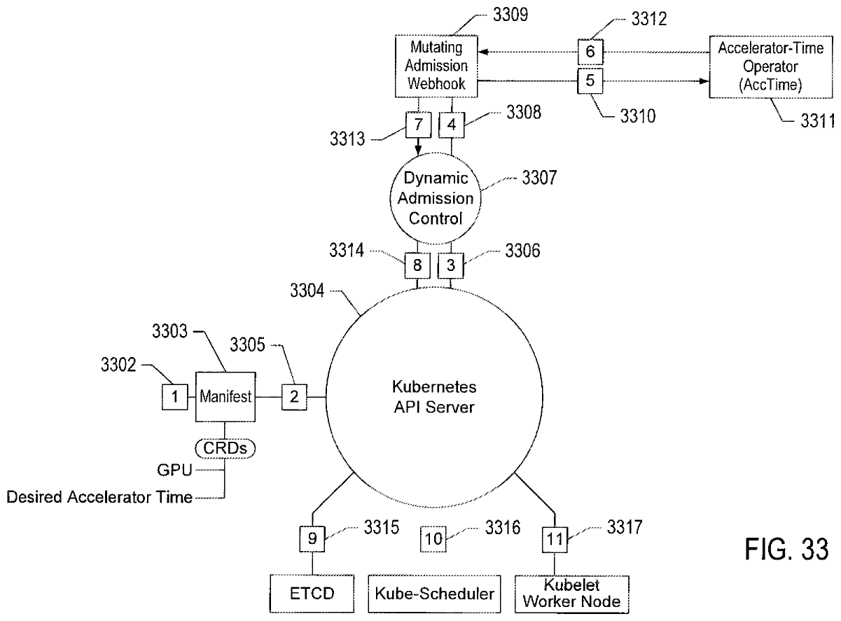

FIG. 33 illustrates a process by which machine-learning-based workloads requiring hardware acceleration are submitted to, and processed by, an enhanced Kubernetes automated orchestration system. Machine-learning-based workloads that include specification of one or more application instances requiring hardware acceleration and specified using ML_CRD fields are referred to, below, as “ML workloads. FIGS. 33-36 use control-flow-like representations that include small, numerically-labeled rectangles representing steps and larger rectangular and circular entities representing components and larger-scale functionalities. In a first step 3302, a user prepares a workload specification for an ML workload that includes ML_CRD fields describing requirements for one or more hardware accelerators and one or more desM metric values. The workload specification may specify one or more application instances for which deployment is requested by the user. The workload specification is part of a manifest 3303 that is submitted to the API Server 3304 of the enhanced Kubernetes automated orchestration system in a second step 3305. The enhanced Kubernetes automated orchestration system identifies the manifest as containing ML_CRD fields and, in a third step 3306, forwards an admission-review request, together with portions of the manifest, to a dynamic-admission-control component 3307 which, in turn, forwards the admission-review request and information extracted from the portions of the manifest, in a fourth step 3308, to a mutating-admission-webwork admission controller 3309. The mutating-admission-webwork admission controller, in a fifth step 3310, forwards the information to an accelerator-time operator 3311. This operator processes the forwarded information and returns, in a sixth step 3312, a node-affinity specification to the mutating-admission-webwork admission controller. The node-affinity specification includes identifying information for one or more candidate Kubernetes worker nodes for hosting ML_CRD application instances specified in the workload. In a seventh step 3313, the mutating-admission-webwork admission controller returns a response to the dynamic admission control 3307 which, in an eighth step 3314, forwards the response to the Kubernetes API server 3304. The response directs the Kubernetes API server to alter the originally submitted manifest in accordance with the node-affinity specification. In essence, the altered manifest now contains information that will allow the Kubernetes scheduler to select appropriate computational nodes for executing the specified workload in accordance with the information provided in the ML_CRD fields. The Kubernetes API server then persists the manifest in the ETCD database, in a ninth step 3315, from which the Kubernetes scheduler retrieves the manifest, in a tenth step 3316, and uses the information that has been altered in accordance with the information provided in the ML_CRD fields, to select nodes on which to deploy one or more application instances specified by the workload and then, in an eleventh step 3317, deploys the workload to the selected nodes and launches execution of the workload.

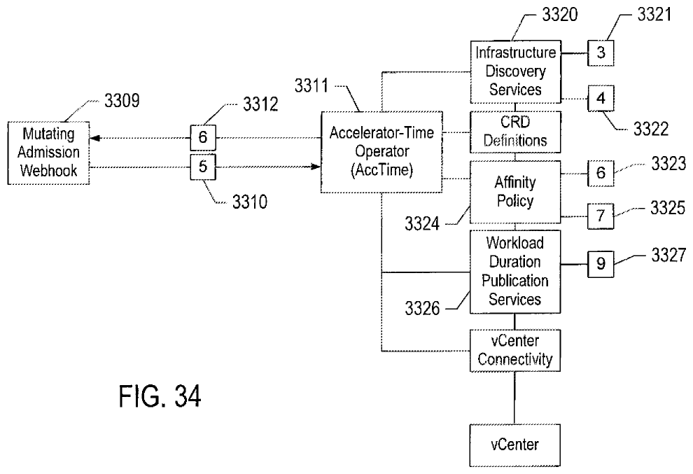

FIG. 34 illustrates additional details regarding operation of the accelerator-time operator. As discussed above, the accelerator-time operator receives the admission-review request and information extracted from portions of the manifest, in step 3310, from the mutating-admission-webwork admission controller 3309. The accelerator-time operator employs infrastructure-discovery services 3322 to identify available worker nodes within the Kubernetes cluster which offer required features and capacities, including accelerators, for ML_CRD application instances. In a twelfth step 3321, the infrastructure discovery services calls vCenter inventory services to translate worker-node names into virtual machine names and to determine the hosts for each of the identified virtual machines. In a thirteenth step 3322, the one or more desM metric values and the determined hosts are provided, by the accelerator-time operator, to an accelerator service admission control, which returns a list of hosts associated with availM metrics that, when compared to the desM metric values, indicate that scheduled maintenance intervals for the hosts do not conflict with the projected training intervals of the specified ML_CRD application instances. The infrastructure discovery services translates the hosts back to Kubernetes worker-node names and, in a fourteenth step 3323, provides these names to an affinity-policy service 3324. In a fifteenth step 3325, the affinity-policy service generates a node-affinity specification based on the received worker-node names. The affinity-policy service selects a set of one or more best worker-node candidates from the list of worker nodes submitted to it, based on various different criteria. The affinity-policy service returns the node-affinity specification to the accelerator-time operator, which invokes the workload duration publication services 3326 to prepare an update message that includes the names of the virtual machines corresponding to the selected nodes and the desM metric values for the ML_CRD application instances, in a sixteenth step 3327, and forwards the update message for updating the training schedule.

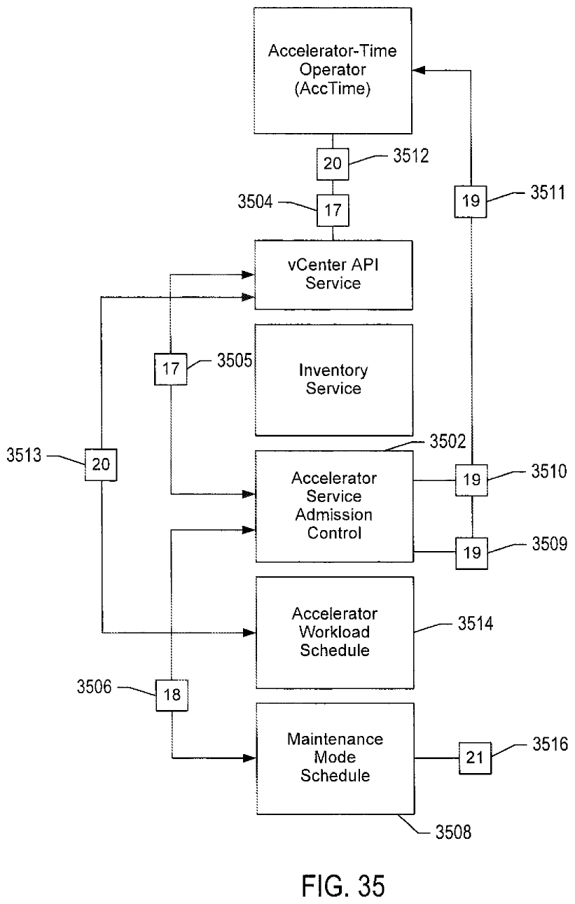

FIG. 35 illustrates vCenter-mediated portions of the currently disclosed methods and systems. As discussed above, the accelerator-service-admission control 3502 receives the one or more desM metric values and the determined hosts from the accelerator-time operator in steps 3504-3505. The accelerator-service-admission control converts the desM metric values into one or more UNIX timestamps in order to carry out the comparison with the availM metric values associated with the determined hosts. In step 3506, the accelerator-service-admission control accesses the maintenance-mode schedule 3508 to determine the UNIX timestamps corresponding to any scheduled maintenance intervals. The accelerator service admission control then returns, in steps 3509-3511, indications of those hosts for which the workload training schedule does not conflict with the scheduled maintenance intervals. As discussed above, in steps 3512-3513, the accelerator-time operator transmits an update message to the accelerator workload schedule 3514 to indicate that one or more hardware accelerators available to one or more of the worker nodes have been claimed for use by the workload. As discussed above, management personnel can update the maintenance schedule in step 3516.

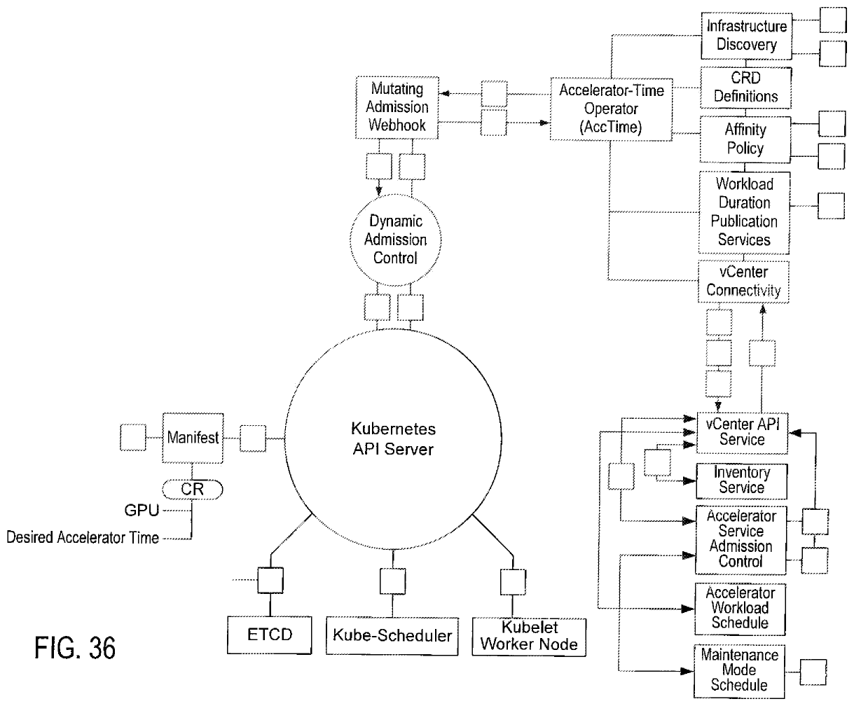

FIG. 36 provides a complete view of the steps and components illustrated in FIGS. 33-35. Thus, custom Kubernetes resource definitions and custom Kubernetes operators are used, in the described implementation, to enhance the Kubernetes automated orchestration system to process ML_CRD fields in workload specifications for machine-learning-based application instances that require accelerator support in order to identify Kubernetes nodes that can provide the required accelerator support for the workloads and that have maintenance schedules that do not conflict with the training schedule associated with the workloads. A logical maintenance-and-training schedule is centrally managed, as a combination of an accelerator workload schedule maintained by Kubernetes and a maintenance schedule maintained by vCenter to provide information needed by Kubernetes to selects hosts with maintenance schedules for ML workloads that do not conflict with training schedules associated with the ML workloads. The logical maintenance-and-training schedule additionally provides information to management personnel to allow management personnel to avoid, when possible, placing virtual machines that are currently executing, or that are scheduled to execute, ML workloads into maintenance mode.

The present invention has been described in terms of particular embodiments, it is not intended that the invention be limited to these embodiments. Modifications within the spirit of the invention will be apparent to those skilled in the art. For example, any of many different implementations of the workload placement methods and systems can be obtained by varying various design and implementation parameters, including modular organization, control structures, data structures, hardware, operating system, and virtualization layers, automated orchestration systems, virtualization-aggregation systems and other such design and implementation parameters.

1. An application-instantiation-and-management system, within a distributed computer system having multiple computational resources and having virtualization services that provide for management and monitoring or virtualization layers within the computational resources that provide computational nodes for execution of application instances, the application-instantiation-and-management system comprising:
a set of computational nodes provided by a selected one or more of the multiple computational resources;
a user interface through which the application-instantiation-and-management system receives a workload specification that specifies one or more ML application instances that are each machine-learning-based, associated with one or more uninterruptible training phases, and require hardware acceleration;
an ML-application-instance component that accesses virtualization services to identify computational nodes suitable for executing the one or more ML application instances and that updates the received workload specification to include a node-affinity specification that specifies the identified computational nodes as candidate hosts for the one or more ML application instances; and
scheduling and deployment components that process the updated workload specification to deploy and launch the specified application instances, including deploying the one or more ML application instances to the candidate hosts.

2. The application-instantiation-and-management system of claim 1
wherein the computational resources are computer systems; and
wherein the computational nodes are virtual machines.

3. The application-instantiation-and-management system of claim 1 wherein an uninterruptible training phase is a period of time during which an ML application instance trains a machine-learning entity, such as a neural network, using hardware acceleration and during which, were the ML application instance terminated, the training phase would need to be restarted from the beginning.

4. The application-instantiation-and-management system of claim 1 wherein the workload specification specifies one or more application instances, including features, capabilities, and constraints associated with the computational modes to which the application instances are deployed the application-instantiation-and-management system.

5. The application-instantiation-and-management system of claim 4 wherein the workload specification includes, for an ML application instance:
an indication of one or more hardware accelerators required for execution of the ML application instance; and
an indication of one or more time intervals, each corresponding to an uninterruptible training phase.

5. The application-instantiation-and-management system of claim 1 wherein computational nodes suitable for executing an ML application instance
provide access to one or more hardware accelerators needed for execution of the ML application instance;
are associated with no scheduled maintenance intervals that overlap any projected time interval for a training phase of the ML application instance; and
provide features, capabilities, and constraints specified for the ML application in a workload specification.

6. The application-instantiation-and-management system of claim 5 wherein the ML-application-instance component accesses the virtualization services to identify, for an ML application instance, computational nodes with maintenance schedules that do not contain maintenance time intervals that overlap any projected time interval for a training phase of the ML application instance and that provide access to one or more hardware accelerators needed for execution of the ML application instance.

7. The application-instantiation-and-management system of claim 6 wherein the ML-application-instance component additionally updates a training schedule to indicate that the time intervals corresponding to the training phases of an ML application instance are claimed by the ML application instance for the computational resource that provides a computational node selected for deployment of the ML application instance.

8. The application-instantiation-and-management system of claim 1 wherein the application-instantiation-and-management system maintains a training schedule that, for each computational resource, indicates time intervals claimed for training phases of ML application instances.

9. The application-instantiation-and-management system of claim 8 wherein the application-instantiation-and-management-system user interface provides access, to system managers and other users, to the training schedule to allow the system managers and other users to check for ML application instances executing training phases on a computational resource before placing the computational resource into maintenance mode or powering down the computational resource.

10. The application-instantiation-and-management system of claim 9 wherein automated management tools access the training schedule through the application-instantiation-and-management-system user interface to decide when to send notifications or alerts to management personnel with regard to possible interruption of training phases executed by ML application instances.

11. The application-instantiation-and-management system of claim 1 wherein the virtualization services maintain a maintenance schedule that, for each computational resource, indicates time intervals scheduled for maintenance of the computational resource.

12. The application-instantiation-and-management system of claim wherein the virtualization services provide access to the maintenance schedule by management personnel and by the ML-application-instance component of the application-instantiation-and-management system.

12. The application-instantiation-and-management system of claim 1 wherein hardware accelerators include graphical processing units and tensor processing units.

13. A method for automatically deploying application instances on computational nodes used by an application-instantiation-and-management system, the computational nodes provided by computational resources of a distributed computer system having multiple computational resources and having virtualization services that provide for management and monitoring of virtualization layers within the computational resources that provide computational nodes for execution of application instances, the method comprising:
receiving a workload specification that specifies one or more ML application instances that are each machine-learning-based, associated with one or more uninterruptible training phases, and require hardware acceleration;
identifying computational nodes of the computational nodes used by the application-instantiation-and-management system that are suitable for executing the one or more ML application instances;
updating the received workload specification to include a node-affinity specification that specifies the identified computational nodes as candidate hosts for the one or more ML application instances; and
deploying the one or more ML application instances to the candidate hosts for execution.

14. The method of claim 13 wherein the virtualization services maintain a maintenance schedule that, for each computational resource, indicates time intervals scheduled for maintenance of the computational resource.

15. The method 14 of claim wherein the virtualization services provide access to the maintenance schedule by management personnel and by the ML-application-instance component of the application-instantiation-and-management system.

16. The method of claim 13 wherein the application-instantiation-and-management system maintains a training schedule that, for each computational resource, indicates time intervals claimed for training phases of ML application instances.

17. The method of claim 16 wherein the application-instantiation-and-management-system provides access, to system managers and other users, to the training schedule to allow the system managers and other users to check for ML application instances executing training phases on a computational resource before placing the computational resource into maintenance mode or powering down the computational resource.

18. The method of claim 13
wherein the workload specification specifies one or more application instances, including features, capabilities, and constraints associated with the computational modes to which the application instances are deployed by the application-instantiation-and-management system; and
wherein the workload specification includes, for an ML application instance,
an indication of one or more hardware accelerators required for execution if the ML application instance; and
an indication of one or more time intervals, each corresponding to an uninterruptible training phase.

19. The method of claim 13 wherein computational nodes suitable for executing an ML application instance
provide access to one or more hardware accelerators needed for execution of the ML application instance;
are associated with no scheduled maintenance intervals that overlap any projected time interval for a training phase of the ML application instance; and
provide feature, capabilities, and constraints specified for the ML application in a workload specification.

20. A physical data-storage device encoded with computer instructions that, when executed by computational resources of a distributed computer system having multiple computational resources and having virtualization services that provide for management and monitoring of virtualization layers within the computational resources that provide computational nodes for execution of application instances, control the computational resources to:
receive, by an application-instantiation-and-management system, a workload specification that specifies one or more ML application instances that are each machine-learning-based, associated with one or more uninterruptible training phases, and require hardware acceleration;
identify computational nodes of the computational nodes used by the application-instantiation-and-management system, by the application-instantiation-and-management system, suitable for executing the one or more ML application instances;
updating the received workload specification, by the application-instantiation-and-management system, to include a node-affinity specification that specifies the identified computational nodes as candidate hosts for the one or more ML application instances; and
deploying the one or more ML application instances to the candidate hosts for execution.
